(19) United States
(12) Patent Application Publication
(10) Pub. No.: US 2012/0226711 A1
(43) Pub. Date: Sep. 6, 2012

(54) DATA-INTERRELATED DYNAMICALLY-UPDATED SCREEN DEVICES

(76) Inventor: Steven D. Lavine, New York, NY (US)

(21) Appl. No.: 13/474,474

(22) Filed: May 17, 2012

Related U.S. Application Data
(63) Continuation-in-part of application No. 12/120,114, filed on May 13, 2008.

(51) Int. Cl. G06F 17/30

(52) U.S. Cl. 707/769; 707/E17.014

(57) ABSTRACT

A method, system, and computer program product for data-interrelated dynamically-updated screen devices is disclosed. The system receives a list of attributes, at least two of the attributes correspond to at least one entity from within the entity dataset. Then, a first screen device is displayed that shows at least one first attribute selected from the list of attributes. The first attribute comprising a first range of first values. The system also displays a second screen device that shows at least one second attribute selected from the list of attributes. The second attribute comprising a second range of second values. A user interacts with the screen devices in order to specify a query, and directs the system to access the entity dataset using the query to retrieve a query result set. The results returned by the query are used to update the screen devices.

### RELATED APPLICATIONS

The present application claims the benefit of priority, under 35 USC 120, to co-pending U.S. patent application Ser. No. 12/120,114, entitled “USER INTERFACE FOR SEARCH METHOD AND SYSTEM” (Attorney Docket No. TRANS.P0001CIP) which is hereby incorporated by reference in entirety.

### FIELD

The present disclosure is directed towards displaying results of database queries, and more particularly to techniques to form and use data-interrelated dynamically-updated screen devices.

### BACKGROUND

Graphical user interfaces have long been able to present GUI widgets in the form of sliders or buttons or other dynamically-updated screen devices to users, and some dynamically-updated screen devices might be populated on the basis of a query/retrieval from a database. Or a particular screen device might be present (or not present) on the basis of a query/retrieval from a database.

However, in some situations, a particular screen device might itself influence the query/retrieval from a database. In such a case, the legacy techniques that merely update or populate aspects of a screen device on the basis of a query/retrieval from a database are deficient.

While legacy techniques can merely re-display results based on an updated query, legacy techniques fail to change the characteristics of the re-displayed screen device based on the results of the query. In some cases the legacy techniques present re-displayed screen devices even when the query results do not comprise any data for the re-displayed screen devices. This legacy practice is often disorienting to a user, and unnecessarily clutters the display.

Thus, techniques for handling data-interrelated dynamically-updated screen devices are needed. Other features and advantages will be apparent from the accompanying drawings, and from the detailed description that follows below.

### SUMMARY

A user interacts with a system having sliders or other screen devices (e.g. sliders showing labels and ranges) in order to specify a query, and directs the system to access a database using the query. The results returned by the query are used to update the sliders with new ranges (depicted on or near the sliders), which new ranges correspond to the ranges of the attributes as actually returned in the retrieved query result set.

The user can further interact with the updated sliders to narrow (or widen) the scope of the query and run another query, which (again) updates the sliders with new ranges that correspond to the ranges of the attributes as actually returned in the updated query result set. This process of refinement of a query based on displays of screen devices that reflect actually-returned database search results can continue in further iterations.

In exemplary embodiments, two or more sliders are related by virtue of their underlying data as returned by operation of the query. For example, in the context of a search for an apartment, a user might use a slider to select “2 bedrooms” for use of that value in a query. Again, strictly as an example, there might be apartments with “2 bedrooms” that fall into 3 price ranges, say “$600-$699”, “$700-$799”, and “$800-$899”, and a “Price Range” slider depicts those three ranges (or more ranges, if more ranges were returned in the actual database search results). The user can narrow the search to include, say only the “$700-$799” range, and thus receive results that include only apartments with “2 bedrooms” and in the price range “$700-$799”.

As in the foregoing example, the results returned by the query are used to update the screen devices with new ranges depicted using the sliders, which new ranges correspond to the ranges of the attributes and attribute values as actually returned in the retrieved query result set.

### BRIEF DESCRIPTION OF THE DRAWINGS

The novel features are set forth in the appended claims. However, for purpose of explanation, several embodiments are set forth in the following figures:

FIG. 1A depicts a display container for data-interrelated dynamically-updated screen devices, according to some embodiments.

FIG. 1B depicts a dataset hierarchy for data-interrelated dynamically-updated screen devices, according to some embodiments.

FIG. 1C is a chart showing a process for data-interrelated dynamically-updated screen devices, according to some embodiments.

FIG. 1D is a schematic of a data-interrelated dynamically-updated screen device, according to some embodiments.

FIG. 1E shows components of a dynamically-updated screen device for data-interrelated dynamically-updated screen devices, according to some embodiments.

FIG. 1F is a flow chart for data-interrelated dynamically-updated screen devices, according to some embodiments.

FIG. 2A depicts samples of entity trees used in systems for data-interrelated dynamically-updated screen devices, according to some embodiments.

FIG. 2B depicts a mesh of entity trees for data-interrelated dynamically-updated screen devices, according to some embodiments.

FIG. 3 depicts an initialized screen device within a display container for data-interrelated dynamically-updated screen devices, according to some embodiments.

FIG. 4 shows a text box displayed within a display container for data-interrelated dynamically-updated screen devices, according to some embodiments.

FIG. 5 shows a query result set characterization displayed within a display container for data-interrelated dynamically-updated screen devices, according to some embodiments.

FIG. 6A shows an updated screen device displayed within a display container for data-interrelated dynamically-updated screen devices, according to some embodiments.

FIG. 6B shows a screen device for forming a ranged value user query as displayed within a display container for data-interrelated dynamically-updated screen devices, according to some embodiments.

FIG. 6C shows a screen device for forming a discrete value user query as displayed within a display container for data-interrelated dynamically-updated screen devices, according to some embodiments.

FIG. 6D shows the results of forming a discrete value user query as displayed within a display container for data-interrelated dynamically-updated screen devices, according to some embodiments.

FIG. 7A shows map screen device controls as displayed within a display container for data-interrelated dynamically-updated screen devices, according to some embodiments.

FIG. 7B shows an entity display collage as displayed within a display container for data-interrelated dynamically-updated screen devices, according to some embodiments.

FIG. 8 is a flow chart of a system for data-interrelated dynamically-updated screen devices, according to some embodiments.

FIG. 9A depicts an initialized screen device within a display container for data-interrelated dynamically-updated screen devices, according to some embodiments.

FIG. 9B depicts an initialized text box screen device within a display container for data-interrelated dynamically-updated screen devices, according to some embodiments.

FIG. 9C depicts results of a query displayed within a display container for data-interrelated dynamically-updated screen devices, according to some embodiments.

FIG. 9D depicts results of a narrowed query displayed within a display container for data-interrelated dynamically-updated screen devices, according to some embodiments.

FIG. 10 depicts a block diagram of a system to perform certain functions of a computer, according to some embodiments.

FIG. 11 depicts a block diagram of an instance of a computer system suitable for implementing an embodiment of the present disclosure.

Like reference characters refer to corresponding parts throughout the drawings.

### DETAILED DESCRIPTION

### Section I: General Terms

Some of the terms used in this description are defined below (in alphabetical order) for easy reference. These terms are not rigidly restricted to these definitions. A term may be further defined by the term's use in other sections of this description.

“Client” means the client part of a client-server architecture. A client is typically a user device and/or an application that runs on a user device. A client typically relies on a server to perform some operations. For example, an email client is an application that enables a user to send and receive email via an email server. In this example, the computer running such an email client may also be referred to as a client.

“Database” (e.g. a database of real estate listings, a database system, etc) means a collection of data organized in such a way that a computer program may quickly select desired pieces of the data. A database is an electronic filing system. In some instances, the term “database” is used as shorthand for a “database management system”. A database may be implemented as any type of data storage structure capable of providing for the retrieval and storage of a variety of data types. For instance, a database may comprise one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

“Screen Device” means any computer graphic imagery viewable by a user. A screen device can accept user input (e.g. as in a slider) or a screen device can merely form a display element (e.g., a map or a banner or a footer of a web page).

“Entity or Entities” means any object that can be stored in or on a volatile or non-volatile storage device. An entity (e.g., a real estate listing, a movie object, etc) can include, without limitation, a representation of a real object stored in an entity dataset.

“Network” means a connection, between any two or more computers, that permits the transmission of data. A network may be any combination of networks including, without limitation, the internet, a local area network, a wide area network, a wireless network, and/or a cellular network.

“Server” means a software application that provides services to other computer programs (and their users) on the same computer or on another computer or computers. A server may also refer to the physical computer that has been set aside to run a specific server application. For example, when the software Apache HTTP Server is used as the web server for a company's website, the computer running Apache may also be called the web server. Server applications may be divided among server computers over an extreme range, depending upon the workload.

“System” means a device or multiple coupled devices.

“User” (e.g. consumer, etc) means an operator of a screen device. A user is typically a person who seeks to acquire a product and/or service. For example, a user may be a woman who is browsing a shopping site for a new cell phone to replace her current cell phone.

“Web browser” means a software program that may display text or graphics or both, from web pages on websites. Examples of a web browser include, without limitation, Mozilla Firefox™ and Microsoft Internet Explorer™.

“Web page” means documents written in a mark-up language including, without limitation, HTML (hypertext mark-up language), VRML (virtual reality modeling language), dynamic HTML, XML (extensible mark-up language), and/or other related computer languages. A web page may also refer to a collection of such documents reachable through one specific internet address and/or through one specific website. A web page may also refer to any document obtainable through a particular URL (uniform resource locator). “Web server” is a server configured for serving at least one web page to a web browser.

### Section II: Descriptions of the Figures

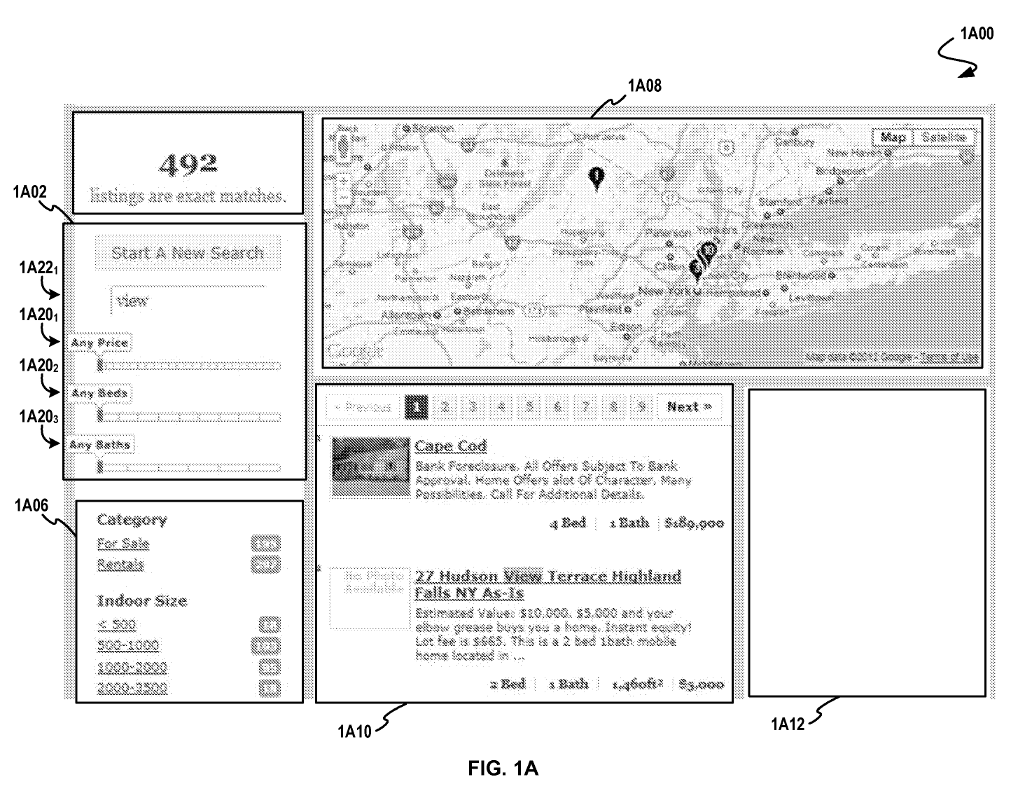

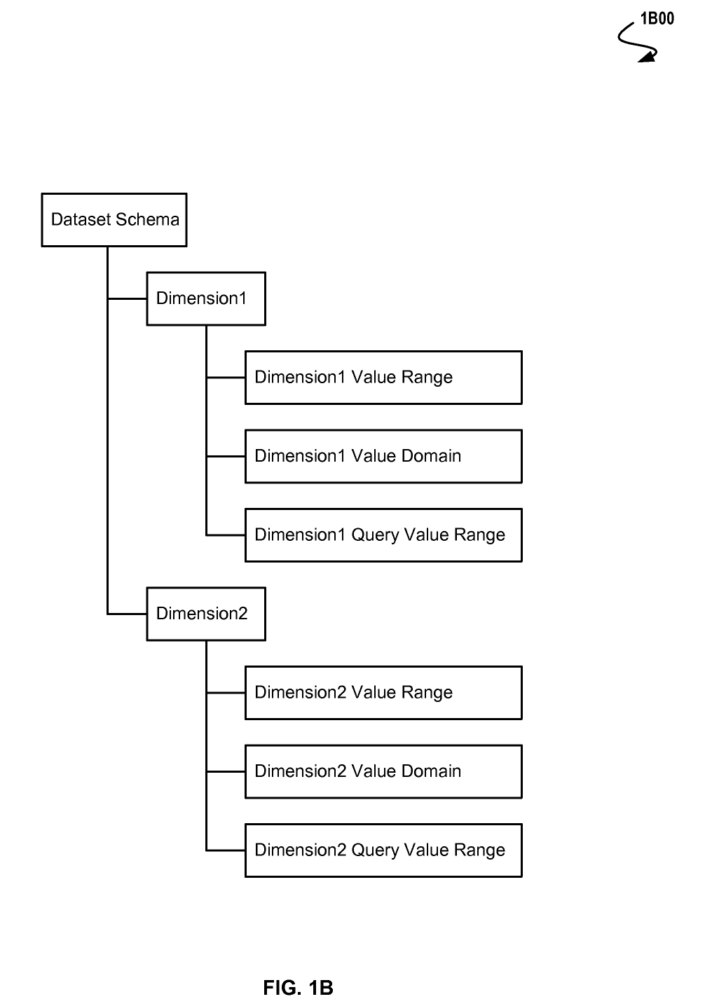

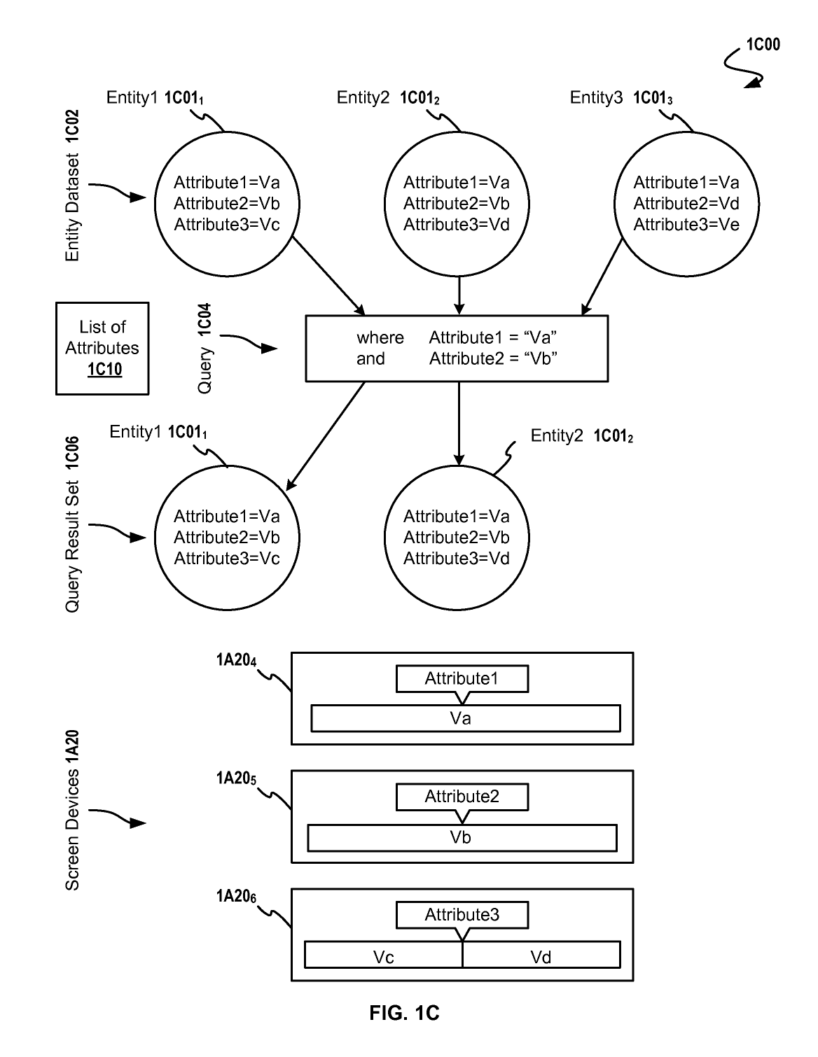

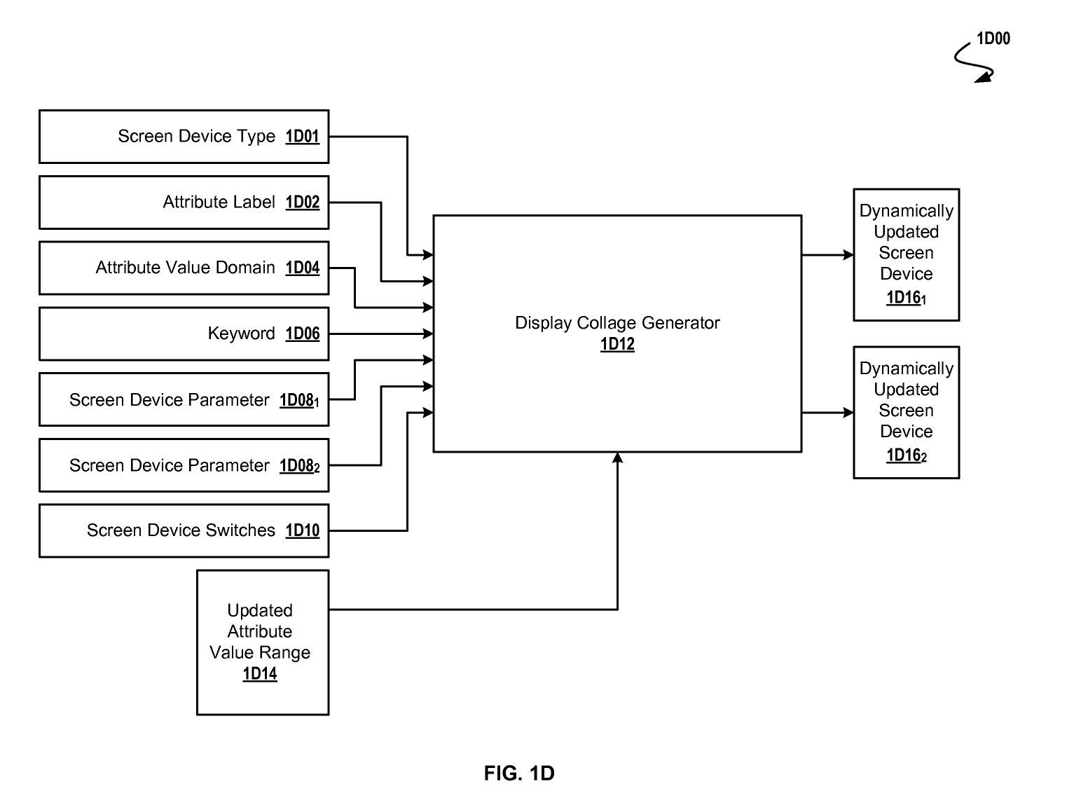

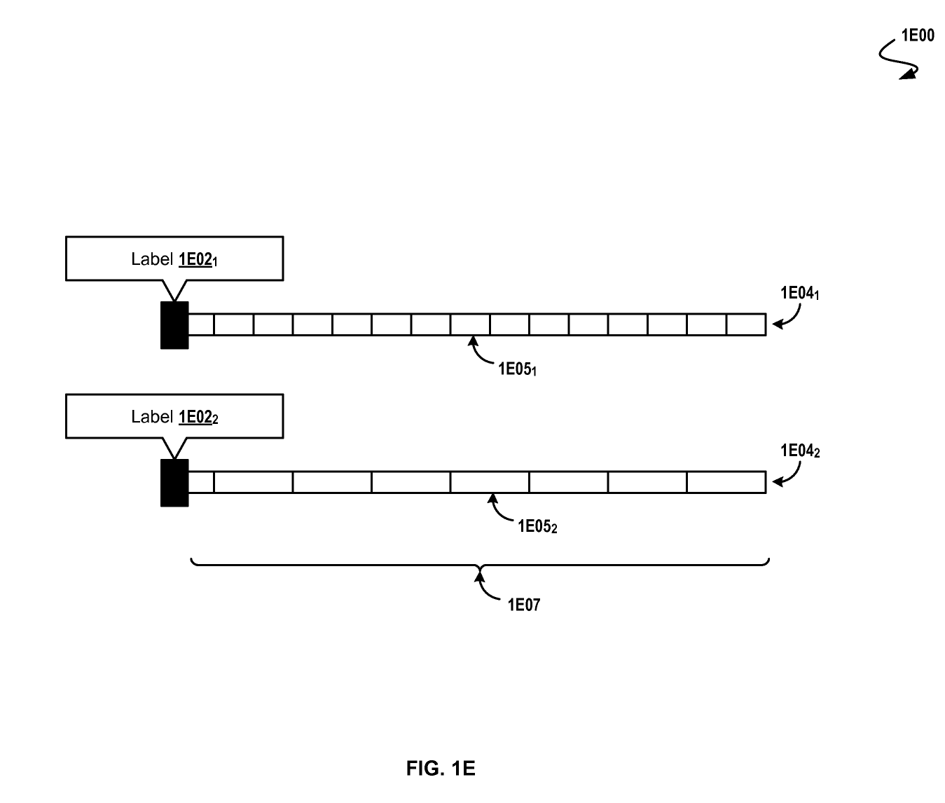

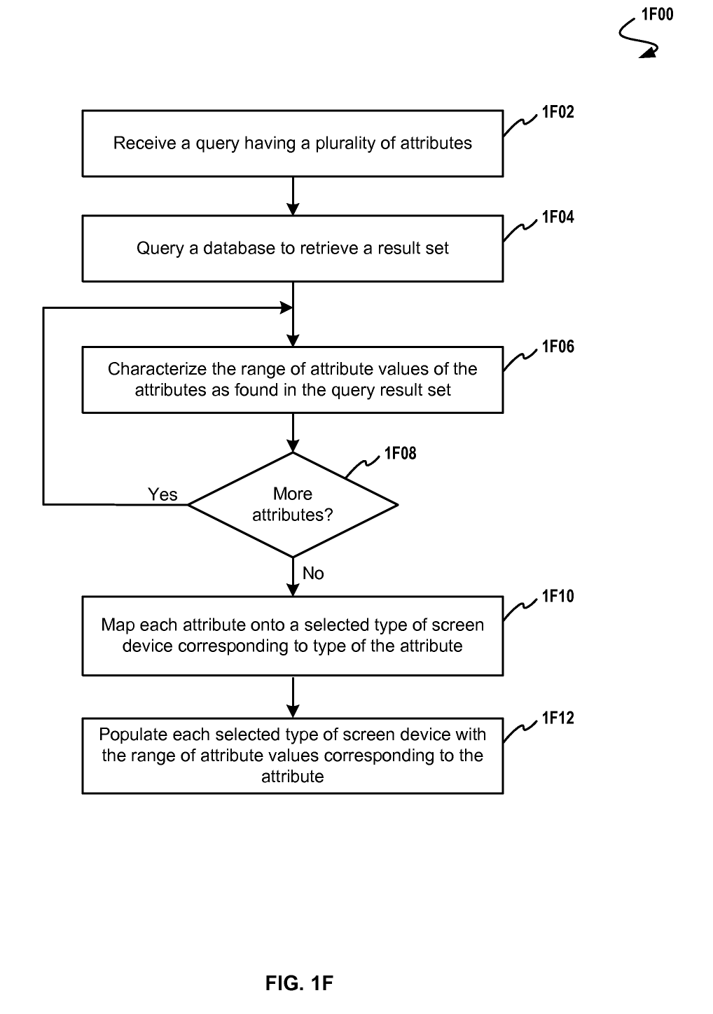

FIG. 1A depicts a display container 1A00 for data-interrelated dynamically-updated screen devices. As an option, the present display container 1A00 may be implemented in the context of the architecture and functionality of the embodiments described herein. Also, the display container 1A00 used in systems or any aspect therein may be implemented in any desired environment.

Strictly as an example, and as shown, the display container 1A00 comprises a query formation viewport 1A02, a results summary viewport 1A06, results detail viewport 1A10, an imagery viewport 1A08, and an ad viewport 1A12. The juxtapositions are purely exemplary and can be arranged differently based on the data to be displayed. Moreover, the enumeration of the aforementioned viewports are not intended to be limiting; instead, embodiments of the present disclosure are limited only by the claims.

In this example, a website comprising a database of real estate listings is searched, and the results of a given search are served to a web page by a web server for presentation in the aforementioned viewports. As shown, a database of greater New York City real estate listings is searched, and the results of a given search are presented in the forms of a populated instance of an imagery viewport 1A08 (e.g. the map, as shown), a populated instance of a results detail viewport 1A10 (e.g. the Cape Cod and Hudson View Terrace listings), and a populated instance of a results summary viewport 1A06 (e.g. the total number of listings by category). Also shown is a query formation viewport 1A02 (see below) and an un-populated instance of an ad viewport 1A12.

The query formation viewport 1A02 shows several sliders, which sliders are dedicated to a depiction of particular attributes of the listings. For example, one of the sliders (see the “Any Price” screen device 1A20₁) is dedicated to depicting the attribute of the listing price. The “Any Price” slider shows a number of divisions, which divisions each represent the ranges of listing prices. Also, for example, one of the sliders (see the “Any Beds” screen device 1A20₂) is dedicated to depicting the attribute of the number of bedrooms. The “Any Beds” slider shows a number of divisions, which divisions each represent the number of bedrooms as given by the listings.

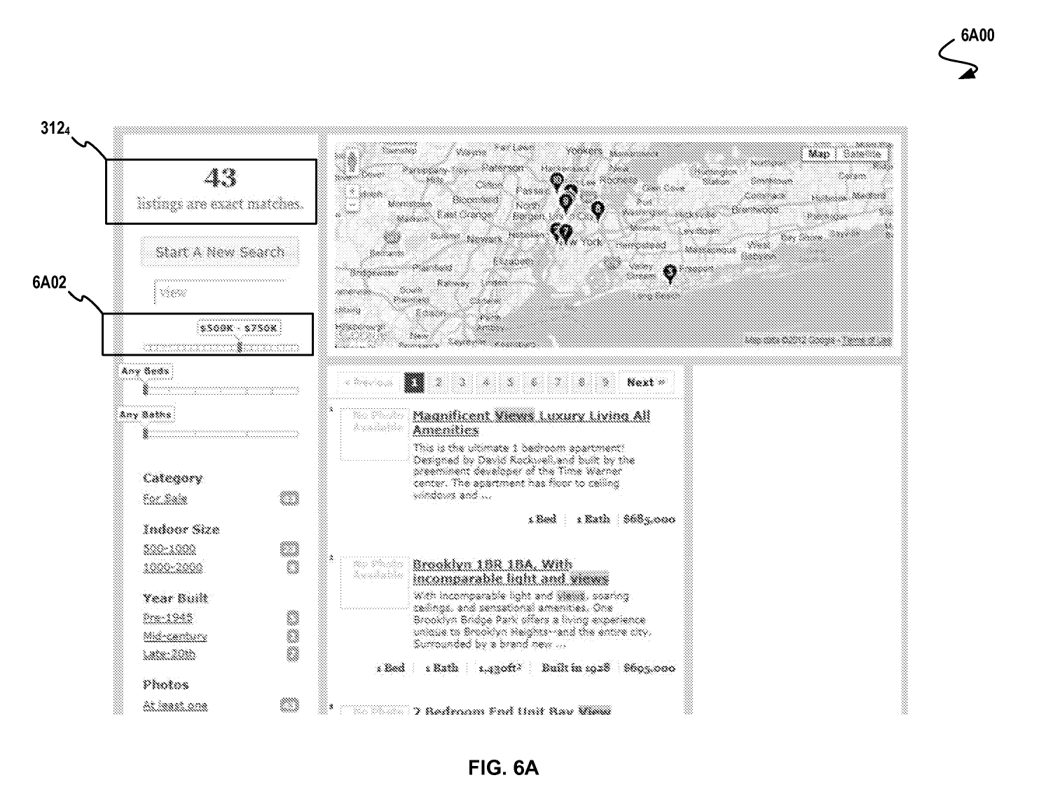

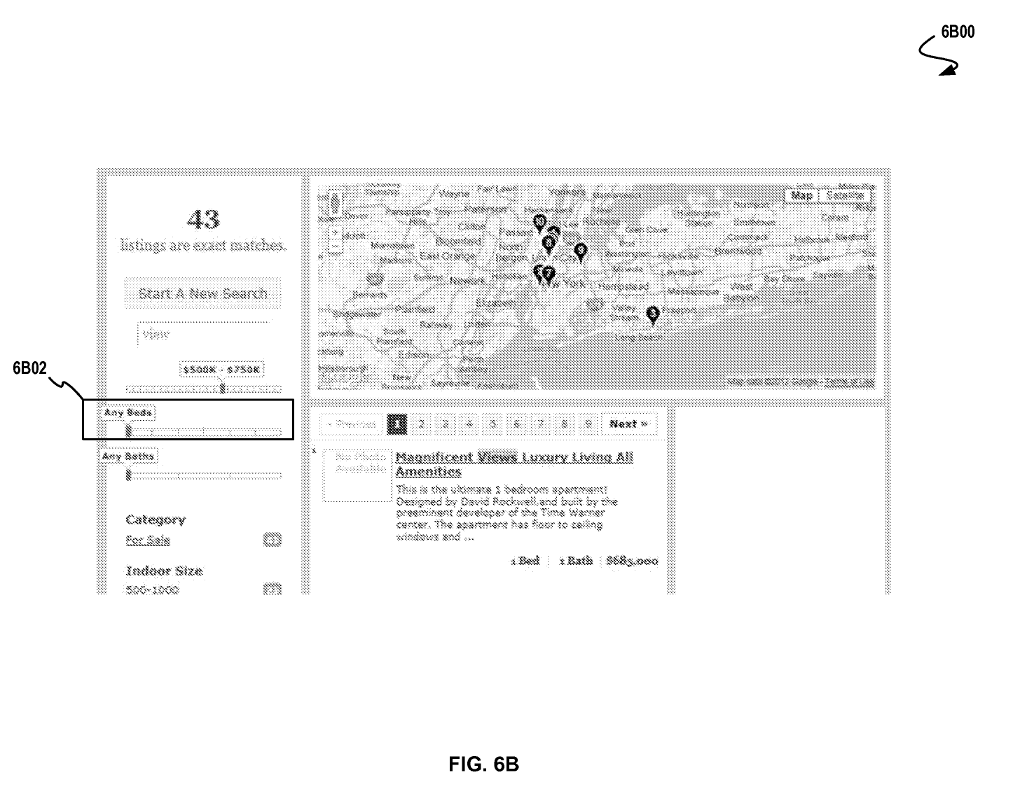

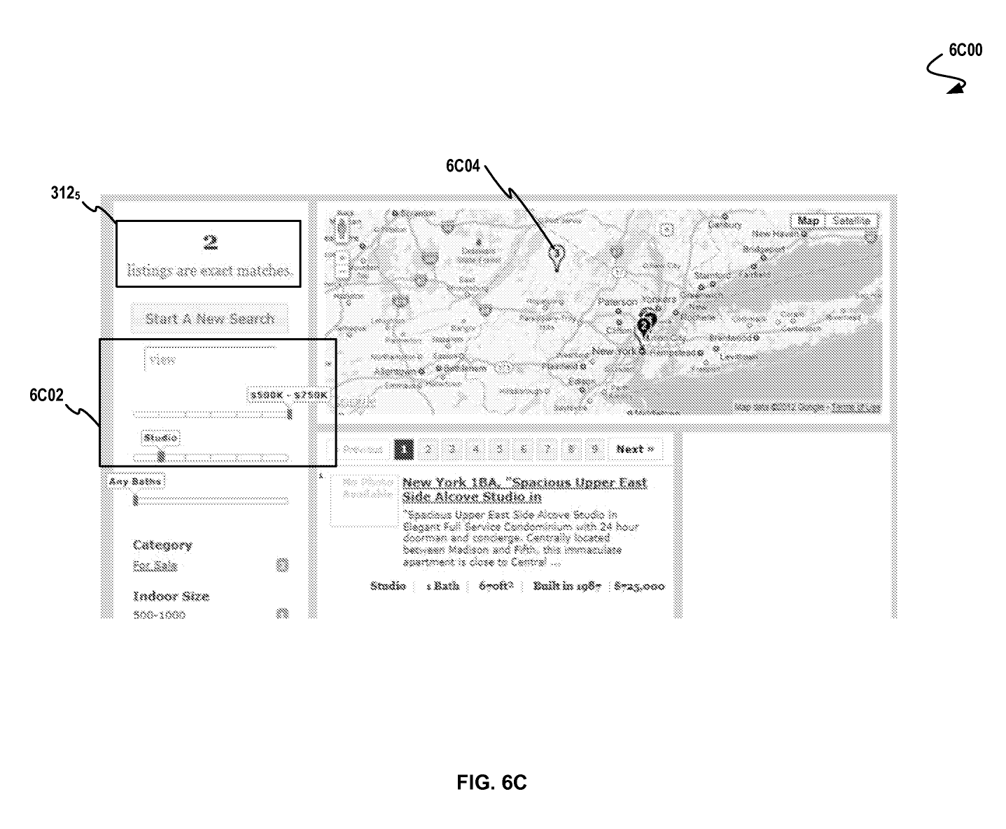

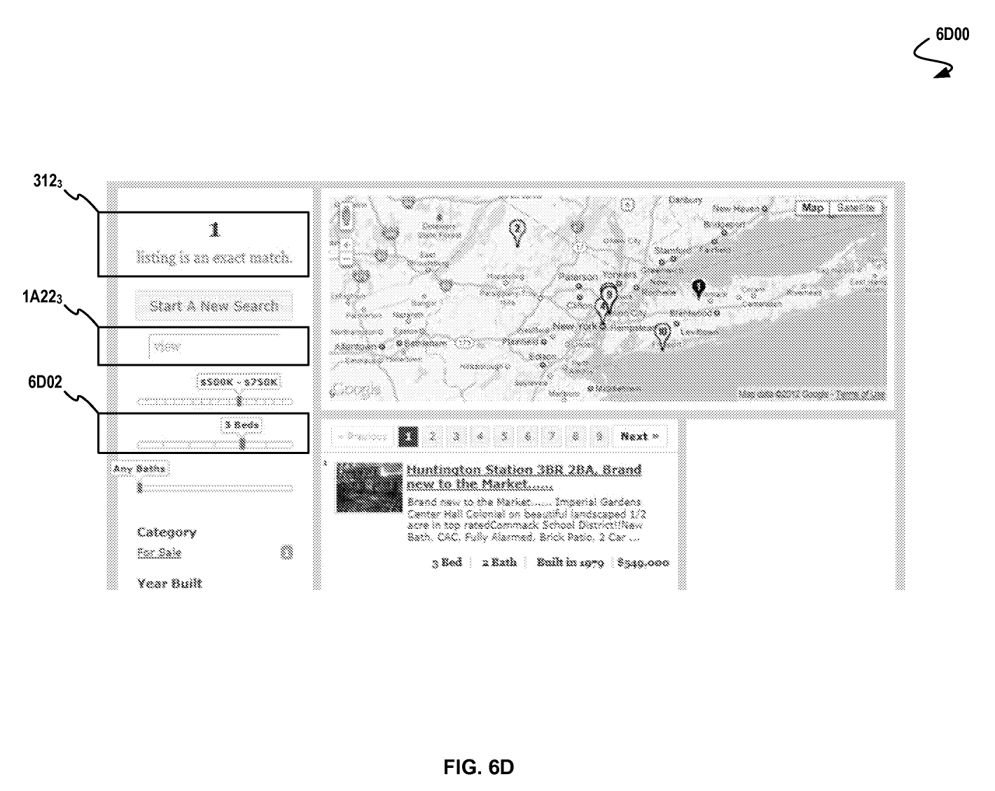

The sliders in the query formation viewport 1A02 can be used to narrow a search, namely by allowing a user to specify an attribute value or an attribute value range. For example, a user might be interested in only listings that have 4 bathrooms. And, in this case, the user might move the “Any Beds” slider to a division representing 3 bedrooms (and FIG. 6D) and rerun the query. The results of the query would return only listings that have 3 bedrooms. Moreover, in accordance with embodiments of the present disclosure, the other sliders that are data-interrelated are dynamically-updated using the appropriate screen device. For example, and as shown, the map within the imagery viewport 1A08 would only show the locations of listings that have 3 bedrooms.

More generally, any one or more of the screen devices (e.g. price slider screen device 1A20₁, beds slider screen device 1A20₂, etc) can be used in the aforementioned viewports and can be dynamically updated based on the query results. The screen devices can be defined based on characteristics of an attribute selected from a list of attributes. Following the example of FIG. 1A, the screen device labeled “Any Price” might be dynamically-updated after a query, and the specific characteristic that is dynamically-updated might be a range of prices corresponding the union of listings that are returned in the result set from the query indicating 3 bedrooms. Of course the example of FIG. 1A is merely illustrative, and more generally, a screen device corresponding to a given second attribute can be dynamically updated in order to represent the values found among the list or range of values corresponding to the second attribute that are returned by the query.

Still further, and again referring to the query formation viewport 1A02 of FIG. 1A, a search can be narrowed by specification of a text item, which text item is to be included in the text of the listing. For example, and as shown, the user had entered the search term “view” in the text box 1A22₁. The query then required that the search term “view” be present in the text of the listing, and accordingly, the results detail viewport 1A10 contains details of only listings where the search term “view” was indeed present in the text of the listing.

Of course, the aforementioned real estate listings are not the only types of entities to be stored in a dataset for searching and displaying, and any of a wide range of entities can be stored in an entity dataset. Nor are the aforementioned attributes the only attributes that fall within the scope of the claims. In fact, some embodiments are configured to receive a list of attributes, where the attributes correspond to one or more entities found within the entity dataset. Still more, any of the attributes of the entities found within the entity dataset comprise values, and the values can be arranged into one or more domains, and, in some cases into one or more ranges.

In the context of the example of FIG. 1A, the attribute of a listing price can be considered to have a domain of “dollars”, and any entities given in a result set attribute of a listing price can comprise prices that can be organized into ranges (e.g. $150,000-$174,999, $175,000-$199,999, etc). Moreover, a given attribute can occur in a dataset, and the given attribute can be specified by specifying a dimension (see FIG. 1B) in a dataset query.

FIG. 1B depicts a dataset hierarchy 1B00 for data-interrelated dynamically-updated screen devices. As an option, the present dataset hierarchy 1B00 may be implemented in the context of the architecture and functionality of the embodiments described herein. Also, the dataset hierarchy 1B00 used in or any aspect therein may be implemented in any desired environment.

A dataset can comprise a plurality of dimensions (e.g. Dimension1, Dimension2, etc). And a dimension can comprise an attribute. For example, one dimension of a real estate listing might be the listing price. A given dimension can in turn comprise a range of values. Continuing this example, the range of values of the dimension of listing price might be $100,000 through $200,000. Such a range can be specified as a range in the form of a numeric range (e.g. “[$100,000, $199,999]”), or a range can be specified as a set of unique values (e.g. “{$109,999, $189,900, 199,900}”, etc).

Further, a dimension can be characterized, and a dimension value domain can be defined (e.g. the domain of “US dollars”). Still further, a dimension query value range can be defined to represent the range or ranges within the domain. For example, a dimension query value range might be defined as comprising range segments, such as is defined in the following range specification syntax [$100,000-$149,999, $150,000-$174,999, $175,000-$199,999].

Thus, some embodiments can use a query to access an entity dataset, and the query can specify a dimension and/or value and/or a value range and/or a dimension query value range, etc. The execution of a query returns a query result set that comprises the entities (if any) that satisfy the query. A subsequent execution of a query might comprise resetting the search parameters. Strictly as an example, a user might want to re-initialize certain search parameters, and would reset/clear a value and/or reset/clear a value range and/or reset/clear a dimension query value range, etc. And, once done, a subsequent execution of a query can be defined (at least in part) by the attributes and attribute values of the cleared/reset search parameters. Of course to clear/reset does not necessarily mean to set to zero. If fact, it could mean to clear/reset to a default value, or clear/reset to a “match all” value such a “*”, or “Any Price”.

FIG. 1C is a chart showing a process 1C00 for data-interrelated dynamically-updated screen devices. As an option, the present a process 1C00 may be implemented in the context of the architecture and functionality of the embodiments described herein. Also, the process 1C00 used in systems disclosed herein or any aspect therein may be implemented in any desired environment.

As shown in FIG. 1C00, the embodiment uses a list of attributes 1C10 to form a query to access an entity dataset 1C02, and the query 1C04 can specify an attribute and/or a dimension and/or a value and/or a value range and/or a dimension query value range, etc. In this case, the query specifies specific values for corresponding attributes selected from the list of attributes. As shown, the query specifies a Boolean expression possibly involving one or more Boolean operators (e.g. “AND”), and possibly involving an attribute (e.g. Attribute1) and a value (e.g. the value “Va”).

The execution of a query returns a query result set 1C06 that comprises the entities (if any) that satisfy the query. In this case, the entity dataset comprises “Entity1 1C01₁”, “Entity2 1C01₂”, and “Entity3 1C01₃”, and the query result set comprises “Entity1 1C01₁” and “Entity2 1C01₂”, together with corresponding attributes and attribute value pairs.

The attributes and attribute value pairs as returned in the result set are used for display of one or more screen devices 1A20 (screen device 1A20₄, screen device 1A20₅, screen device 1A20₆). In this example, the attribute value range for Attribute1 (from within the query result set) is only “Va”. And the attribute value range for Attribute2 is only “Vb”. And the attribute value range for Attribute3 is “Vc” and “Vd”. Accordingly, the screen devices 1A20 show the attributes and attribute values as were actually found in the query result set. Again, in this example, Attribute1 has only attribute value “Va”, and Attribute2 has only attribute value “Vb”, but Attribute3 takes on multiple attribute values, namely in the attribute value range {“Vc”, “Vd”}. The screen device 1A20₆ shows the range of values, namely the range of values actually returned in the entities given in the query result set.

The screen device 1A20₆ is but one species of a genus of possible screen devices. Although a slider is shown and described in the foregoing, other species of screen devices 1A20 are conveniently used in order to display varying aspects of the query result set. For example, icons superimposed on a geographic map screen device can be used to depict aspects of the query result set. Moreover, a computer-implemented display widget or a screen device in the form of a class or method can be implemented in order to provide conveniences to programmers.

FIG. 1D is a schematic 1D00 of a data-interrelated dynamically-updated screen device. As an option, the present schematic 1D00 may be implemented in the context of the architecture and functionality of the embodiments described herein. Also, the schematic 1D00 or any aspect therein may be implemented in any desired environment.

The schematic as shown includes a display collage generator 1D12, which display collage generator serves to layout (e.g. into a display container) one or more screen devices and to update one or more screen devices with updated display values. For example, a display collage generator 1D12 takes as an input a screen device type 1D01 (e.g. a slider, a map, etc) and one or more characteristics pertaining to the input instance of a screen device type 1D01. Such one or more characteristics can be provided in the form of an attribute label 1D02, an attribute value domain 1D04, one or more screen device parameters 1D08 (e.g. screen device parameter 1D08₁, screen device parameter 1D08₂, etc), and/or one or more screen device switches 1D10. In some cases a particular screen device type 1D01 can use text as input, such as a keyword 1D06.

For reasons of performance and other reasons, a display collage generator 1D12 can take as an input an updated attribute value range 1D14. Strictly as an example, one or more dynamically-updated screen devices 1D16 (e.g. dynamically-updated screen device 1D16₁, dynamically-updated screen device 1D16₂) can be composited using a display collage generator 1D12 and an initial set of inputs, and then the dynamically-updated screen devices 1D16 can be updated/redisplayed to show an updated aspect based on updated attribute value range 1D14. Such an occurrence might happen immediately after a system retrieves a query result set, and finds an updated value being included in the query result set. When the updated value (or values) represents a range that differs from a previous query result set, then a corresponding one or more dynamically-updated screen devices 1D16 can be updated using an aspect of the updated attribute value range 1D14 (see FIG. 1E). As indicated, a dynamically-updated screen device can be formed using a single dynamically-updated screen device, or it can be formed as a compound dynamically-updated screen device employing two or more instances of a dynamically-updated screen device. Strictly as an example, a dynamically-updated screen device can be formed of a slider screen device and its label (see FIG. 1E), and each of the slider and the label can be independently dynamically updated.

FIG. 1E shows components of a dynamically-updated slider screen device 1E00 for data-interrelated dynamically-updated screen devices. As an option, the present a dynamically-updated slider screen device 1E00 may be implemented in the context of the architecture and functionality of the embodiments described herein. Also, the dynamically-updated slider screen device 1E00 used in systems disclosed herein or any aspect therein may be implemented in any desired environment.

Depicted are two instances of dynamically-updated slider screen devices 1E04, specifically, the dynamically-updated slider screen device 1E04₁, and the dynamically-updated slider screen device 1E04₂. Also depicted are two instances of dynamically-updated slider label screen devices 1E02, specifically, the dynamically-updated slider label screen device 1E02₁, and the dynamically-updated slider label screen device 1E02₂. As was indicated in the discussion of FIG. 1A, a slider can be used for depicting an attribute. In the discussion of FIG. 1A, one of the sliders (see the “Any Beds” screen device 1A20₂) is dedicated to depicting the attribute of the number of bedrooms. The “Any Beds” slider shows a number of divisions, which divisions each represent the number of bedrooms as given by the listings. And, as is shown in FIG. 1E, a slider (see the “Any Beds” slider) is dedicated to depicting the attribute of the number of bedrooms. The dynamically-updated slider screen devices 1E04 can use display features (e.g. lines, colors, etc) to depict a number of segments or divisions (as shown), which divisions 1E05 (e.g. division 1E05₁, division 1E05₂) each represent a value or range of values as pertains to the slider's corresponding dynamically-updated slider label screen device. Strictly as an example, a dynamically-updated slider label screen device can depict a dimension, or a value, or a range of values, or any other depiction, and can use text and/or images in the depiction. Moreover, a dynamically-updated slider label screen device can change its value as the slider is operated. Still more, the number of divisions can be updated dynamically.

The segments or divisions can each represent a discrete value (e.g. “1”, “12”, “33”, etc), or a division can represent a range of values (e.g. “1-11”, “12-32”, “33-44”, etc). Moreover, a slider division series 1E07 can represent the full range of values found in a query result set as pertaining to the full range of values found corresponding to a particular attribute.

The dynamically-updated slider screen device of this FIG. 1E is by no means the only type of dynamically-updated screen device, and other types of dynamically-updated screen devices are shown and described infra.

FIG. 1F is a flow chart 1F00 for data-interrelated dynamically-updated screen devices. As an option, the present flow chart 1F00 may be implemented in the context of the architecture and functionality of the embodiments described herein. Also, the flow chart 1F00 used in systems disclosed herein or any aspect therein may be implemented in any desired environment.

As shown, a system following the flow chart 1F00 might be configured to receiving a list of attributes known to be of interest to a user when querying to find or select a particular entity (or set of entities) from within an entity dataset. In the heretofore-described examples, the attributes pertain to real estate listings. The system might then display one or more of the attributes using appropriate screen devices, and the user can manipulate the screen devices so as to form a query. The system receives the query (see operation 1F02) and executes a query (see operation 1F04) to a dataset (e.g. a database, a file, a list, etc). Upon receipt of the query result set, the system can characterize the values of the attributes as are actually found in the query result set (see operation 1F06). For example, if a query were formed to access only real estate listings that have the search term “view” present in the text of the listing, then it might follow that only the more expensive listings would appear in the query result set. And it might be that the range of values of the attribute “Listing price” has a lower bound of $150,000 and an upper bound of $198,900. In such a case, the range of the values of the attribute as are actually found in the query result set can be mapped onto a screen device (see operation 1F10). This process is performed for each attribute of interest (see decision 1F08).

Now, having the range of the values of the attributes, then the mapped-to screen device can be populated (see operation 1F12) in order to depict the range of values.

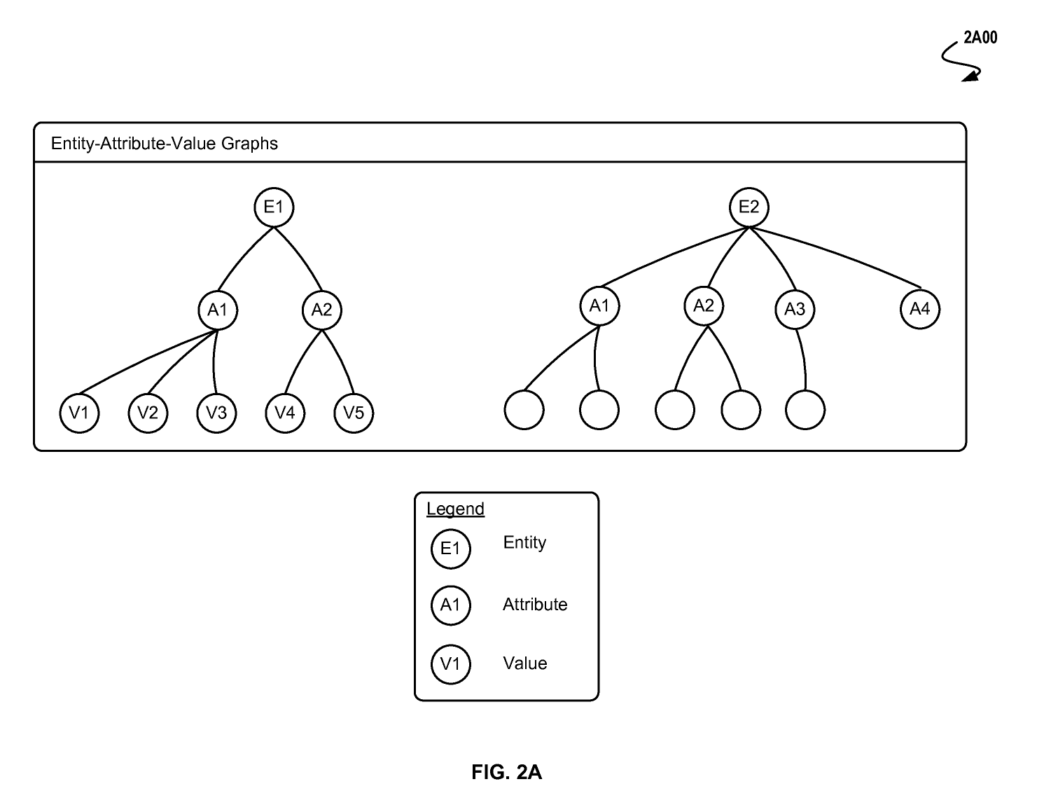

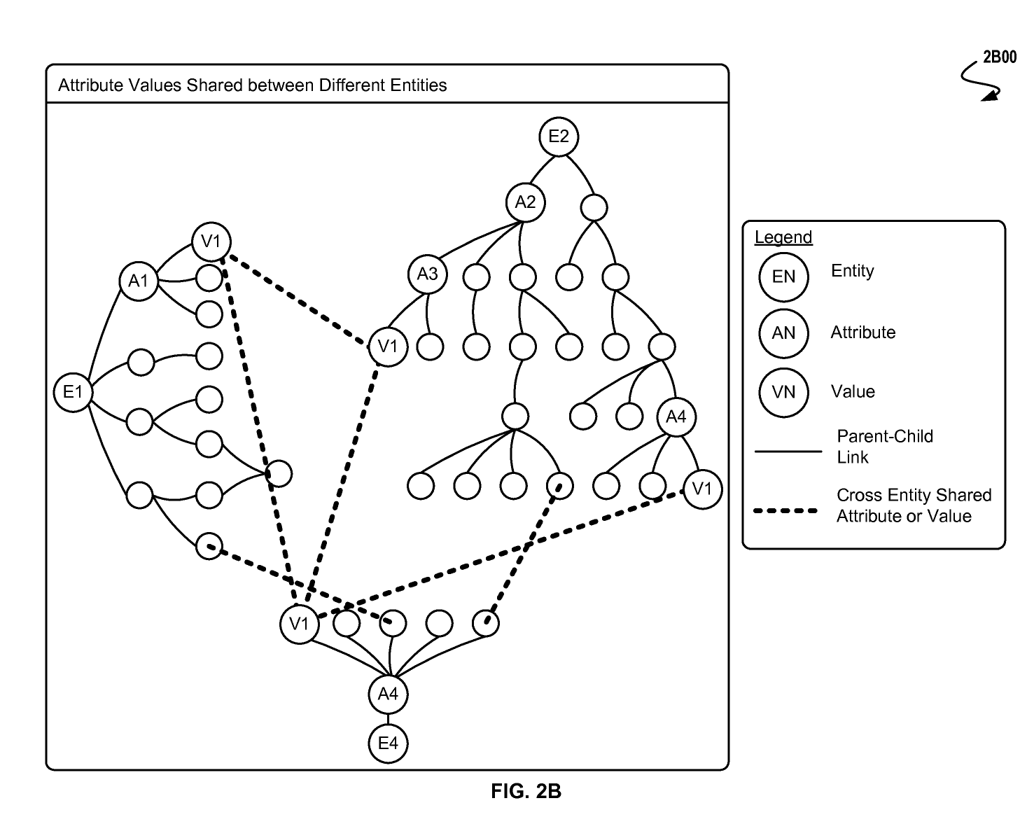

FIG. 2A depicts samples of entity trees 2A00 used in systems for data-interrelated dynamically-updated screen devices. As an option, the present entity trees 2A00 may be implemented in the context of the architecture and functionality of the embodiments described herein. Also, the entity trees 2A00 used in systems or any aspect therein may be implemented in any desired environment.

As shown, the entity trees 2A00 comprise an entity root (e.g. node E1, node E2, etc), under which lie attributes (e.g. node A1, node A2, etc). And further, under a given attribute lies that attribute's value or values. Strictly as examples, E1 might be a particular residential property, and A1 might refer to the attribute “schools”, and V1, V2, V3 might refer respectively to “Soho Elementary School”, “Soho Middle School”, and Soho High School”. Of course the foregoing is strictly an example, and other tree topologies are possible—even topologies where an attribute has null values.

An entity tree is merely a graphical representation of an entity from within an entity dataset, and the entity or relationships between entities from within an entity dataset can be stored in any convenient representation (i.e. not necessarily as a tree).

FIG. 2B depicts a mesh of entity trees 2B00 for data-interrelated dynamically-updated screen devices. As an option, the present entity trees 2B00 may be implemented in the context of the architecture and functionality of the embodiments described herein. Also, the entity trees 2B00 used in systems or any aspect therein may be implemented in any desired environment.

In some situations, a plurality of entities can share the same attributes, and those attributes can in turn share the same or some of the same values. For example, a first property in Soho might share the same high school (e.g. “Soho High School”) with a second property in Soho, and yet not share the same middle school. Multiple entities can share the same attributes (or not share attributes), and entities can share the same attribute values (or not share attribute values), as shown.

Thus, any pair of entities that share the same attributes or share the same attribute values are data-interrelated, and are advantageously searched using techniques such as are found in the herein disclosed systems and methods for data-interrelated, dynamically-updated screen devices.

As shown, two or more entities (e.g., “E1”, “E2”) can each have their own respective hierarchy having child attributes, and child attribute values. And any two or more entities can exhibit a relationship in the form of a cross entity shared attribute, or cross entity shared attribute value. Such cross entity relationships are shown as heavy dotted lines in FIG. 2B. In some cases, a cross entity shared attribute value is deemed to occur anytime when the attribute value matches. In other cases, a cross entity shared attribute value is deemed to occur only when both the attribute value matches and also the attribute matches. For example, a cross entity match might be deemed based on occurrence of the attribute value “view” regardless of whether or not the attribute value “view” were a child of (for example) the attribute “balcony” or child of (for example) the attribute “backyard”. In other situations, a cross entity shared attribute value match might be deemed to occur only if the attribute value “view” and the attribute “balcony” both occur across a given pair of entities.

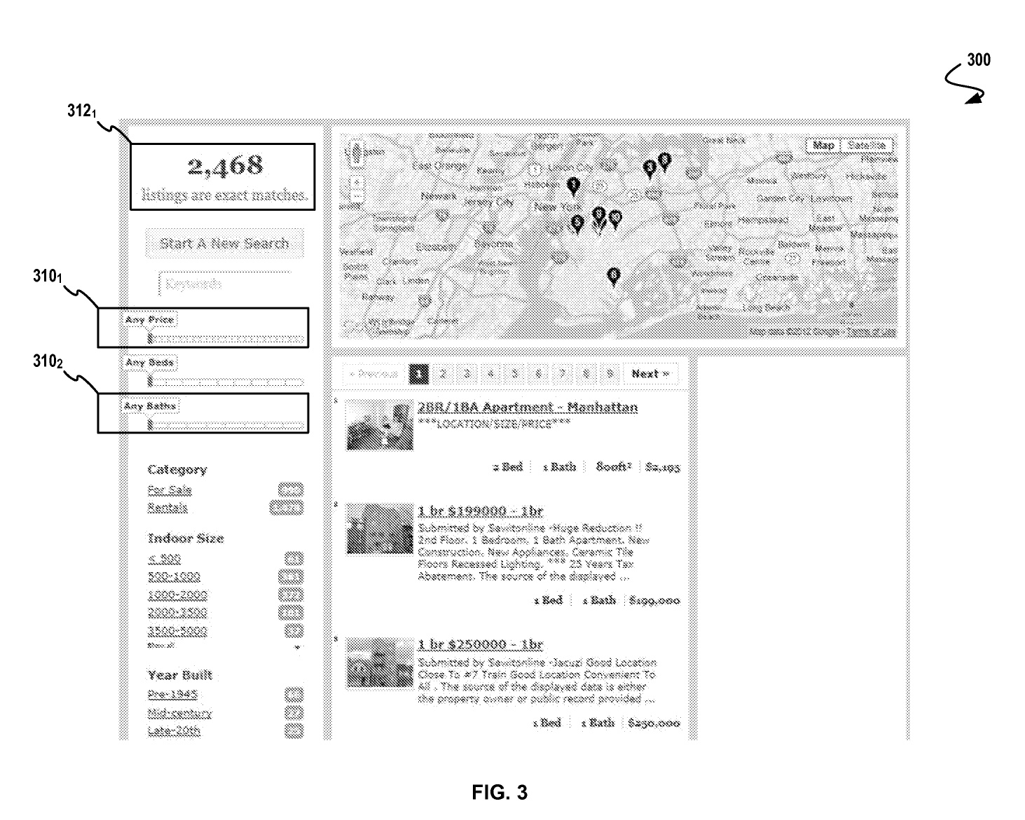

FIG. 3 depicts an initialized screen device within a display container 300 for data-interrelated dynamically-updated screen devices. As an option, the present display container 300 may be implemented in the context of the architecture and functionality of the embodiments described herein. Also, the display container 300 used in systems disclosed herein or any aspect therein may be implemented in any desired environment.

In the context of a computer-implemented method for searching an entity dataset using data-interrelated dynamically-updated screen devices, some embodiments are initialized based on receiving a list of attributes that correspond to the characteristics of the entities found in the entity dataset. The list of attributes might be determined on the basis of a computer-implemented analysis of the entities found in the entity dataset, or the list of attributes can be defined by a human operator.

In the specific embodiment shown, the list of attributes comprises {“listing price”, “number of bedrooms”, and “number of bathrooms”}. And, the shown sliders are initialized with labels, where a label corresponds to a respective attribute. The initialized sliders 310 (e.g. initialized slider 310₁, initialized slider 310₂) show the initial value “Any Price” (referring to {“listing price”) and “Any Baths” (referring to “number of bathrooms”). Of course other initial values are reasonable. As shown the settings indicated by the initialized sliders 310 are used in an initial query for accessing the entity dataset in order to retrieve an initial query result set. Characteristics of the query result set are displayed in display container 300, for example, the number of entities returned from the initial query can be displayed (see match count screen device 312₁).

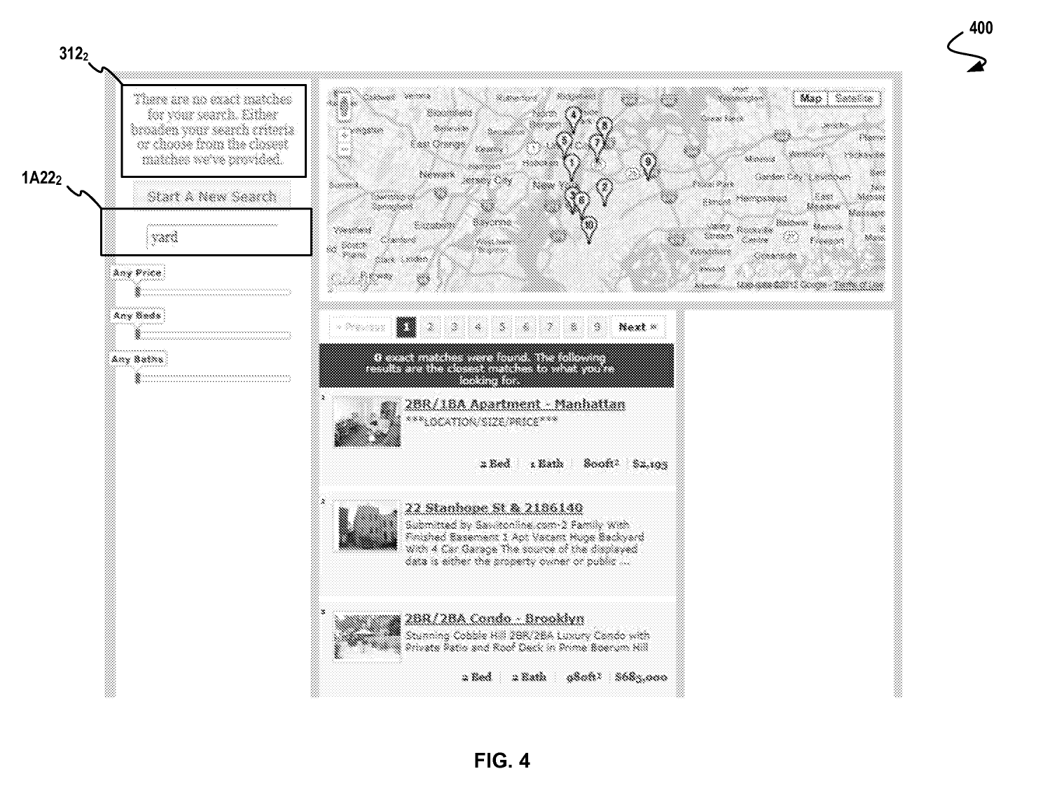

FIG. 4 shows a text box displayed within a display container 400 for data-interrelated dynamically-updated screen devices. As an option, the present display container 400 may be implemented in the context of the architecture and functionality of the embodiments described herein. Also, the display container 400 used in systems disclosed herein or any aspect therein may be implemented in any desired environment.

Uses of the initialized sliders 310 can be augmented using a text box 1A22₂. In this embodiment, the text box contains the search term “yard”. For example, and as shown, the user had entered the search term “yard” in the text box and the query then required that the search term “yard” be present in the text of the listing. In this illustrative example, there were no matching listings, and accordingly, and as shown, the fact of no matching listings is displayed (see match count screen device 312₂).

Even given the fact of no matching listings from a query, the display container 400 can remain displayed in a manner that is not disorienting for a user. For example, the previous results set might be displayed in one or more viewports. In various embodiments, the composition of one or more viewports is performed in a manner that results in changes in the display that are not disorienting for a user. In fact some embodiments perform analysis on a first query result set in comparison with a second query result set, and the second query result set is characterized for producing non-disorienting display changes within a display container.

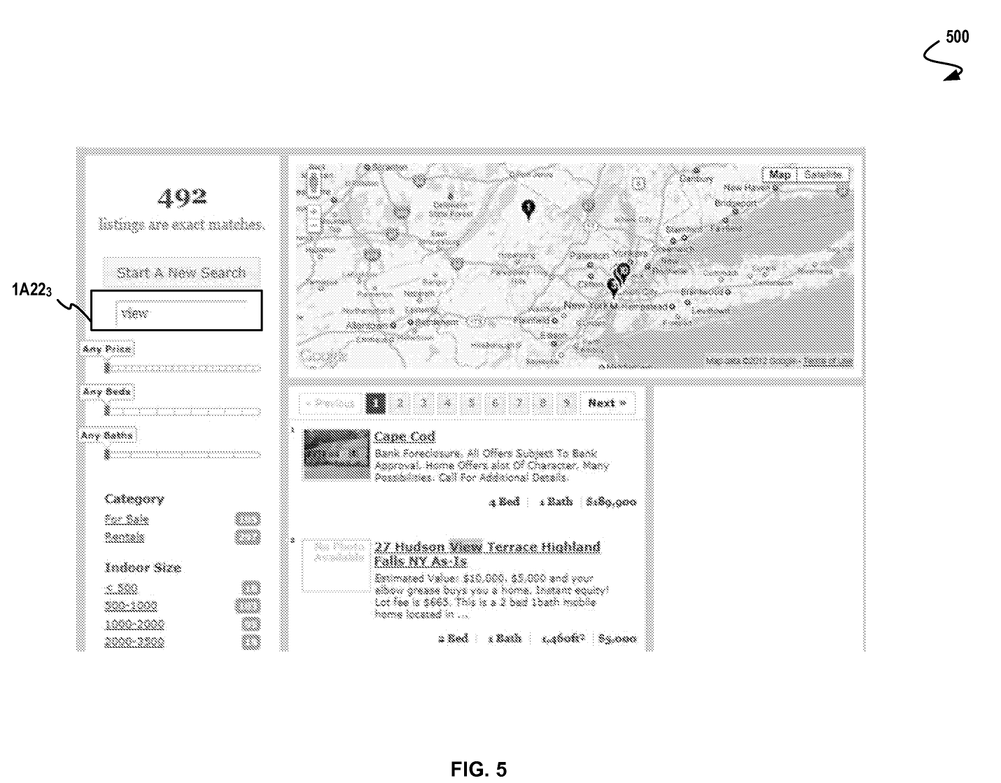

FIG. 5 shows a query result set characterization displayed within a display container 500 for data-interrelated dynamically-updated screen devices. As an option, the present display container 500 may be implemented in the context of the architecture and functionality of the embodiments described herein. Also, the display container 500 used in systems disclosed herein or any aspect therein may be implemented in any desired environment.

As shown, the query included the search term “view” in the text box 1A22₃ and thus, the query then required that the search term “view” be present in the text of the listing. In this illustrative example, there were some matching listings, which count can be shown in an updated screen device displayed within a display container.

FIG. 6A shows an updated screen device displayed within a display container 6A00 for data-interrelated dynamically-updated screen devices. As an option, the present display container 6A00 may be implemented in the context of the architecture and functionality of the embodiments described herein. Also, the display container 6A00 used in systems disclosed herein or any aspect therein may be implemented in any desired environment.

The display container 6A00 depicts updated screen devices. Specifically, the resulting dynamically-updated slider screen device 6A02 includes a label, the label showing a range of “$500K-$750K”. The resulting dynamically-updated slider screen device 6A02 also includes the aforementioned segments or divisions (as shown), which divisions each represent a value or range of values as pertains to the slider's corresponding dynamically-updated slider label screen device. The particular display of the label showing a price range of “$500K-$750K” indicates that at least one entity from the returned query result set falls into the range of “$500K-$750K”. There may be entities from the returned query result set that falls into ranges other than the displayed range of “$500K-$750K”, and various embodiments provide for selecting a particular range from a set of ranges. Also shown is an updated instance of match count screen device 312₄.

The display container 6A00 depicts sufficient screen devices for the user to form a ranged value user query (see FIG. 6B).

FIG. 6B shows a screen device for forming a ranged value user query as displayed within a display container 6B00 for data-interrelated dynamically-updated screen devices. As an option, the present display container 6B00 may be implemented in the context of the architecture and functionality of the embodiments described herein. Also, the display container 6B00 used in systems disclosed herein or any aspect therein may be implemented in any desired environment.

A ranged value user query can be formed using the screen devices as shown in FIG. 6B. For example a user might be interested in those listing with a “view” (see the discussion of FIG. 5), and in the price range of “$500K-$750K” but only if the listing is a “Studio”. Such a query can be formed using the screen devices within region 6C02 as shown in FIG. 6C. More specifically, the foregoing user query includes a discrete value, which discrete value can be displayed using a discrete value slider (e.g. slider instance 6B02) and label.

FIG. 6C shows a screen device for forming a discrete value user query as displayed within a display container 6C00 for data-interrelated dynamically-updated screen devices. As an option, the present display container 6C00 may be implemented in the context of the architecture and functionality of the embodiments described herein. Also, the display container 6C00 used in systems disclosed herein or any aspect therein may be implemented in any desired environment.

The display container 6C00 shows aspects of the query result set of the aforementioned discrete value user query, namely the aspect that there are only “2” exact matches (see the updated instance of match count screen device 312₅). The map shows the relative locations of the exact matches. Further, the map shows relative locations of a “fuzzy” match (see the fuzzy match location 6C04). In this and other embodiments, the query result set can comprise both exact matches (as previously discussed) and “fuzzy matches”. In some embodiments, the searches yield results which may not be a 100% exact match but still have relevance. For example, in the embodiment of FIG. 6C, the property labeled “3” was not a “Studio”, yet it is included in the result set due to the fuzzy algorithm assessment of relevance to the query. The presentation of fuzzy matches have the effect of suggesting to the user to broaden the query in order to obtain additional results.

Indeed, suppose the user notes the existence of the fuzzy match location 6C04, and wishes to consider possibilities other than “Studio”, say two bedrooms (e.g., by moving the slider until the label shows “2 Beds”). In such a case, the screen device for forming a discrete value user query (e.g. slider instance 6B02) can be used. In such a case, the user selects the slider to move from “Studio” to “2 Beds”.

Certain aspects of fuzzy match techniques used in some embodiments of the present application are related to material disclosed in United States Patent Application entitled “SEARCH METHOD AND SYSTEM AND SYSTEM USING THE SAME,” having Ser. No. 10/534,627 filed on Jan. 3, 2006 (now U.S. Pat. No. 7,461,051), which is hereby incorporated by reference.

FIG. 6D shows the results of forming a discrete value user query as displayed within a display container 6D00 for data-interrelated dynamically-updated screen devices. As an option, the present display container 6D00 may be implemented in the context of the architecture and functionality of the embodiments described herein. Also, the display container 6D00 used in systems disclosed herein or any aspect therein may be implemented in any desired environment.

The techniques described herein use a discrete value user query for accessing the entity dataset using a query to retrieve a query result set, and then, using the retrieved query result set, updating the screen devices (e.g. showing a range or ranges comprising values of attributes being included in the query result set).

In this example, the discrete value user query included a listing price range $500K-$750K, the specification of “3 Beds” 6D02, and a requirement for a “view” (see text box 1A22₃). The retrieved query result set returned just “1” exact match (see match count screen device 312₃), and that match is displayed in the updated map.

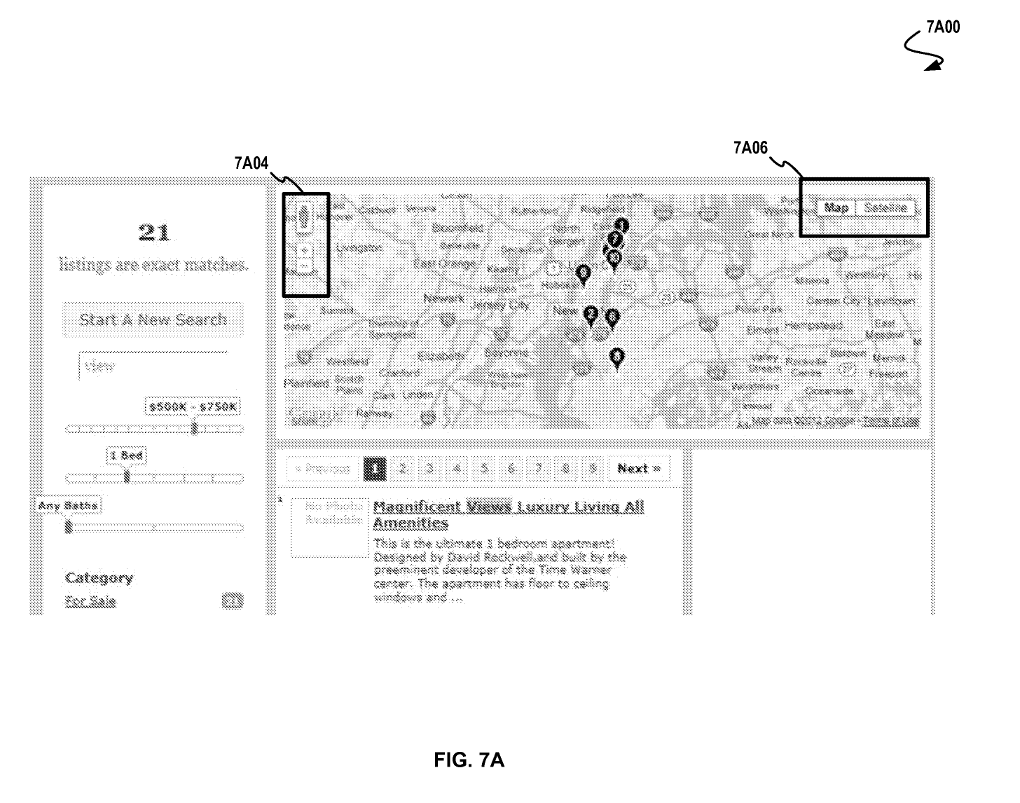

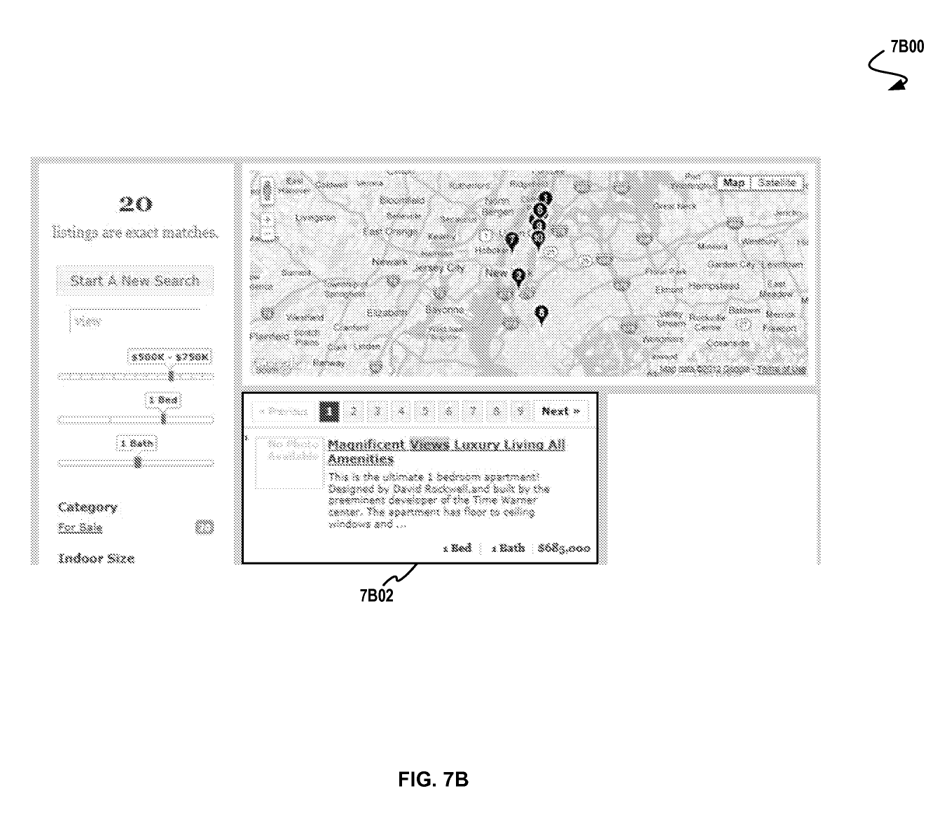

FIG. 7A shows map screen device controls as displayed within a display container 7A00 for data-interrelated dynamically-updated screen devices. As an option, the present display container 7A00 may be implemented in the context of the architecture and functionality of the embodiments described herein. Also, the display container 7A00 used in systems disclosed herein or any aspect therein may be implemented in any desired environment.

In addition to the computer-implemented updating of screen devices, some embodiments include user controls. As shown, display container 7A00 includes map screen device controls, namely map zoom controls 7A04 and map mode controls 7A06. In exemplary cases, after analyzing the retrieved query result set, the system updates the screen devices in accordance with the contents of the retrieved query result set. In the specific case of a map screen device, the zoom (and other map display characteristics) can be automatically set by the system. For example, the zoom of a map screen device might be set so as to display all of the returned entities as icons, where all of the icons fit within the displayed portion of the map screen device. Of course, a map screen device is but one type of screen device, and other update techniques apply to other types of screen devices.

FIG. 7B shows an entity display collage as displayed within a display container 7B00 for data-interrelated dynamically-updated screen devices. As an option, the present display container 7B00 may be implemented in the context of the architecture and functionality of the embodiments described herein. Also, the display container 7B00 used in systems disclosed herein or any aspect therein may be implemented in any desired environment.

The shown entity display collage 7B02 gives user controls to navigate through a plurality of entities. In this specific embodiment, a first entity (from among a plurality of entities) is displayed, and aspects of the entity are given in the visualization of the entity display collage.

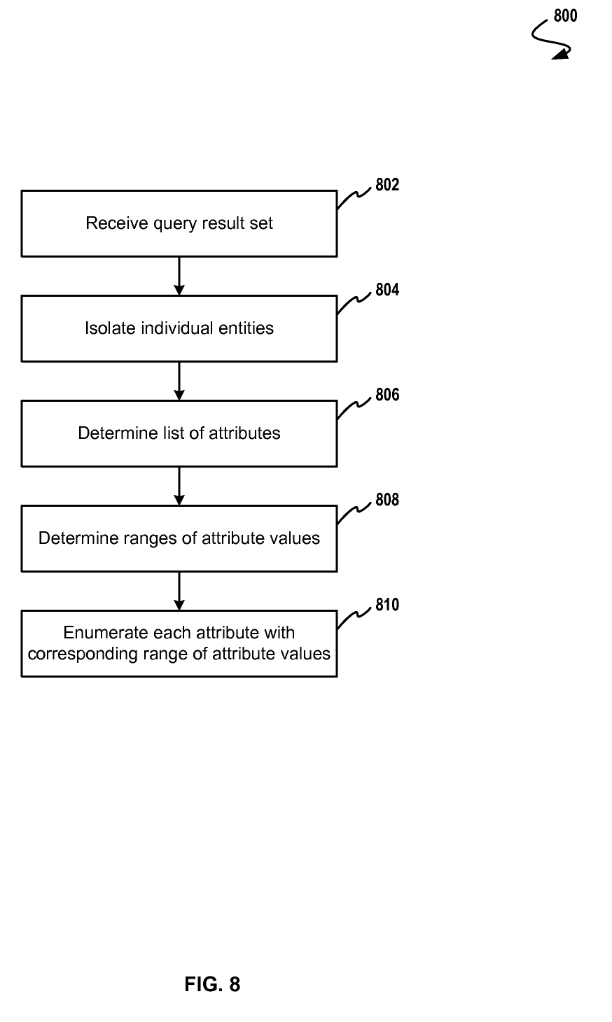

FIG. 8 is a flow chart of a system 800 for data-interrelated dynamically-updated screen devices. As an option, the present system 800 may be implemented in the context of the architecture and functionality of the embodiments described herein. Also, the system 800 to determine attribute value ranges or any aspect therein may be implemented in any desired environment.

Some of the foregoing disclosure has described sliders that are dynamically-defined, at least in part using a received query result set (e.g. see operation 802). In some embodiments screen devices (e.g. sliders) are presented at a first time, then used for querying a database, and again presenting the screen devices (at a second time). In exemplary cases, multiple screen devices are presented at one time, presenting the screen devices in a manner to show ranges of values of attributes. Determining the ranges can be performed using the techniques of system 800.

As shown, system 800 serves to isolate individual entities as returned in the query result set (see operation 804), and from that set, determine list of attributes (see operation 806), and then, from the list of attributes, to determine ranges of attribute values (see operation 808). Having the ranges of attribute values, then to enumerate each attribute with corresponding range of attribute values (see operation 810). Strictly as an example, Table 1 depicts such a transformation.

TABLE 1

| Attribute = Value | Possible Ranges | Comment |
|---|---|---|
| Listing Price = $100,000 | $0-$99,000 | The possible ranges can |
| Listing Price = $200,000 | $100,000-$499,000 | be linear or non-linear, |
| Listing Price = $500,000 | $400,000-$500,000 | or can be continuous or |
| | | discontinuous. |
| Bedrooms = “1” | Discrete, | Can be analyzed as |
| Bedrooms = “2” | contiguous ranges | numeric ranges. |
| Bedrooms = “3” | | |
| Rating = “PG” | Discrete | Can be analyzed as non- |
| Rating = “PG-13” | | overlapping non-numeric |
| Rating = “R” | | ranges. |

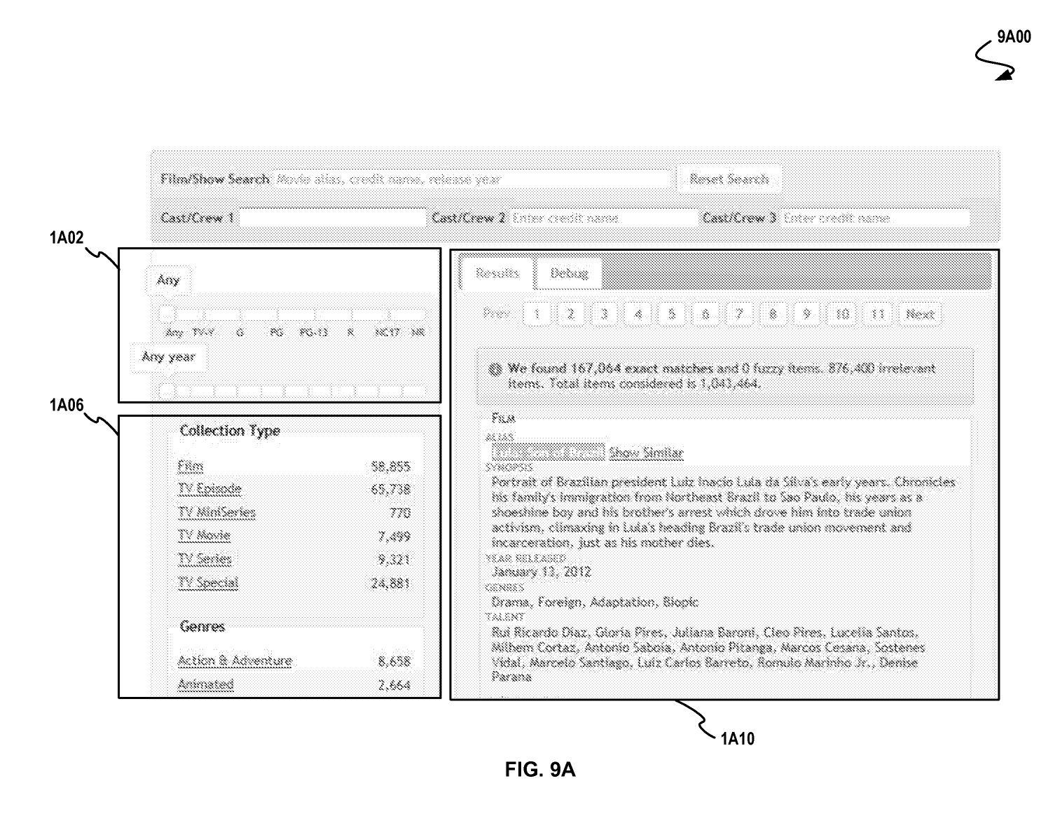

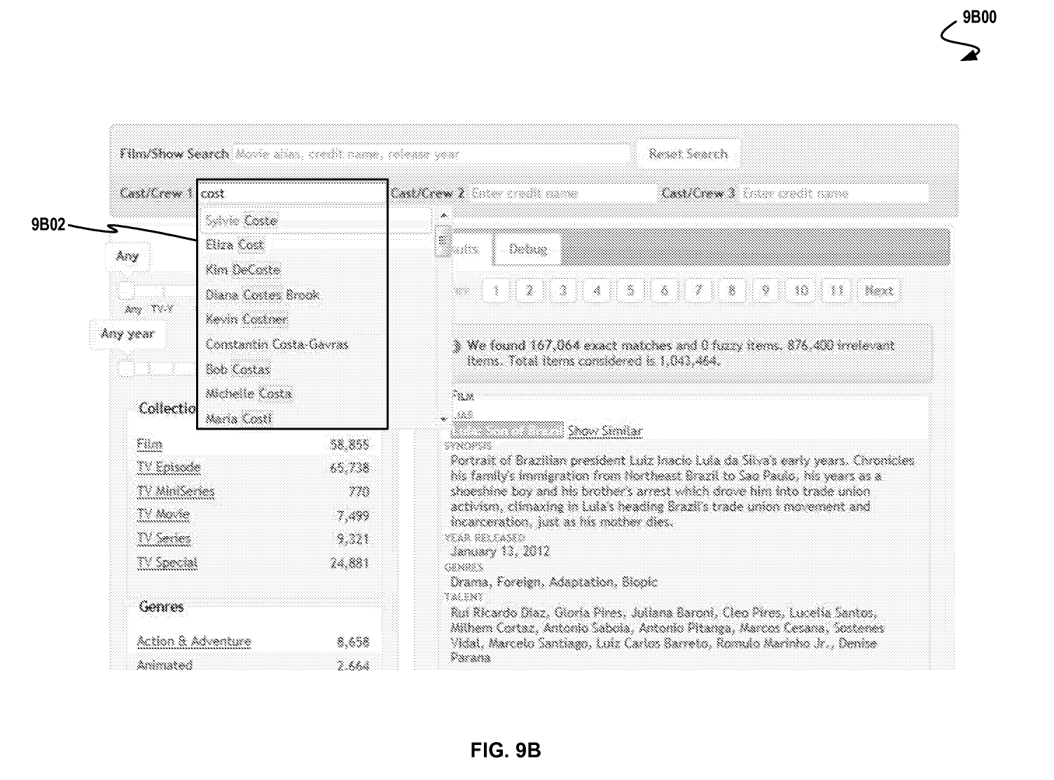

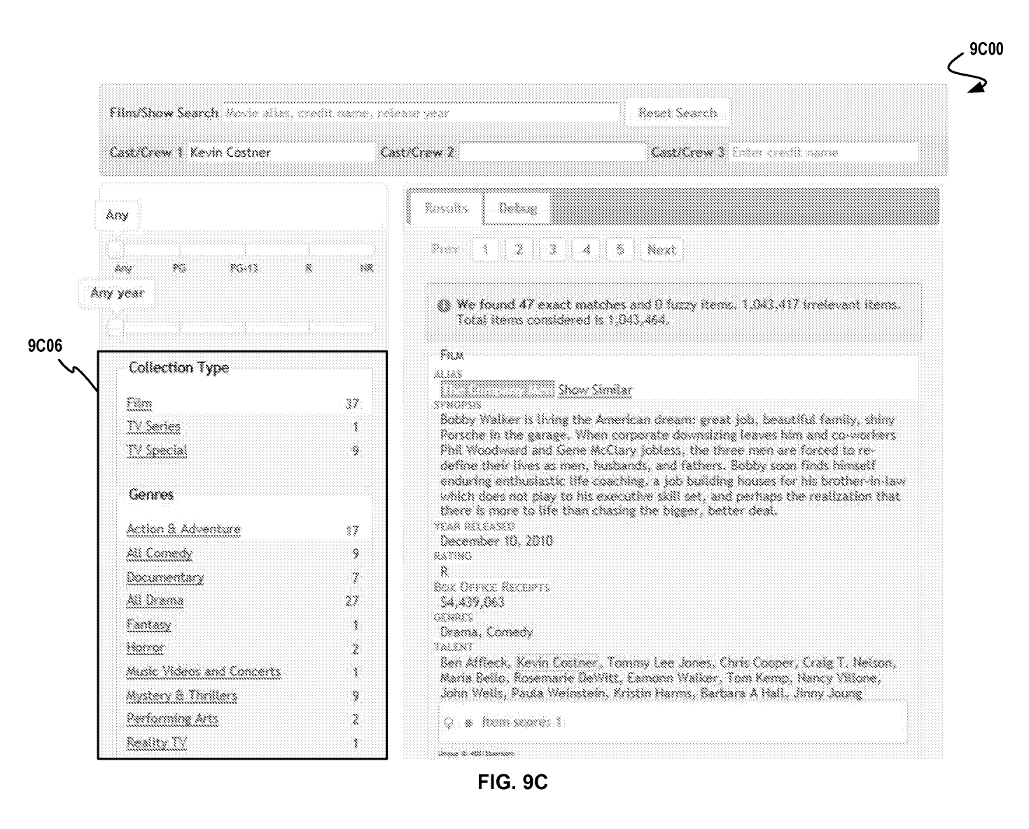

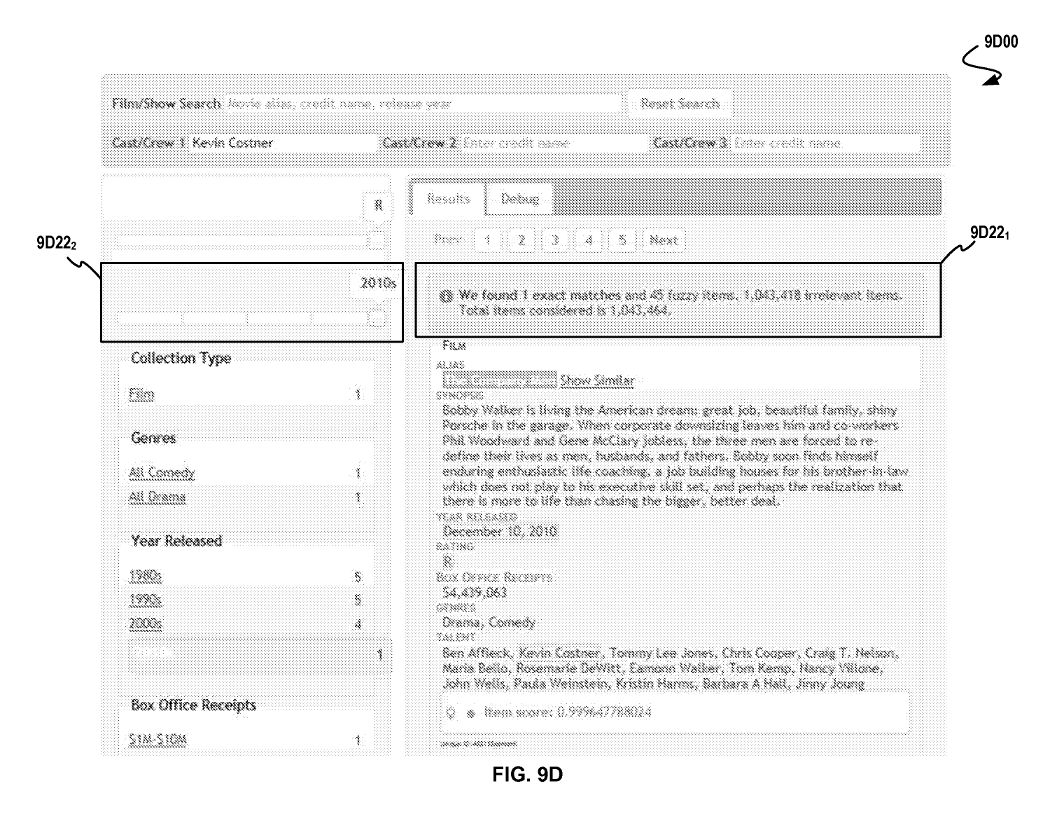

FIG. 9A depicts an initialized screen device within a display container 9A00 for data-interrelated dynamically-updated screen devices. As an option, the present display container 9A00 may be implemented in the context of the architecture and functionality of the embodiments described herein. Also, the display container 9A00 used in systems disclosed herein or any aspect therein may be implemented in any desired environment.

The embodiment shown highlights a query formation viewport 1A02, a results summary viewport 1A06, and a results detail viewport 1A10. Further, the embodiment shown provides a user interface to aid a user processing films. The attributes (cast/crew, year, etc) pertain to entities (e.g. films) that are retrieved from an entity dataset comprising movies. In operation, a user might interface with the initialized screen devices to select a rating (e.g. “PG”) and possibly other attribute values (e.g. a year, a cast member, etc). The system will then process the query formed. In this example, the query formed is for “Any” rating, and “Any year”, and the query returns the matching entities. In this case, the query result set 1C06 returns “167,064 exact matches”.

Of course a query can be more narrowly formulated using any of the techniques herein, including using a text box screen device.

FIG. 9B depicts an initialized text box screen device within a display container 9B00 for data-interrelated dynamically-updated screen devices. As an option, the present display container 9B00 may be implemented in the context of the architecture and functionality of the embodiments described herein. Also, the display container 9B00 used in systems disclosed herein or any aspect therein may be implemented in any desired environment.

Given a portion of text as typed into the text box, the text box screen device expands to include a pick-list screen device 9B02. In this example, the portion of text is “cost”, which is a portion of the name of a cast member, namely “Kevin Costner”. Selecting the name “Kevin Costner” from the pick-list screen device 9B02 re-runs a query to require the attribute “cast/crew 1” to include “Kevin Costner”.

FIG. 9C depicts results of a query displayed within a display container 9C00 for data-interrelated dynamically-updated screen devices. As an option, the present display container 9C00 may be implemented in the context of the architecture and functionality of the embodiments described herein. Also, the display container 9C00 used in systems disclosed herein or any aspect therein may be implemented in any desired environment.

The action of re-running the query to require the attribute “cast/crew 1” to include “Kevin Costner” returns 47 exact matches, as shown. Moreover the values in the screen devices within the results summary viewport for “Kevin Costner” 9C06 indicates 17 “Action & Adventure” films (while considering “Any” rating and “Any Year” of release).

FIG. 9D depicts results of a narrowed query displayed within a display container 9D00 for data-interrelated dynamically-updated screen devices. As an option, the present display container 9D00 may be implemented in the context of the architecture and functionality of the embodiments described herein.

The action of re-running the query to further require the rating attribute to be the discrete value “R” returns just 1 exact match (see result 9D22₁, as shown). Moreover, the values in the screen devices within the query formation viewport indicates there is only one discrete value for rating, namely “R”, and that the film was released in the decade of the “2010s” (see result 9D22₂ as shown).

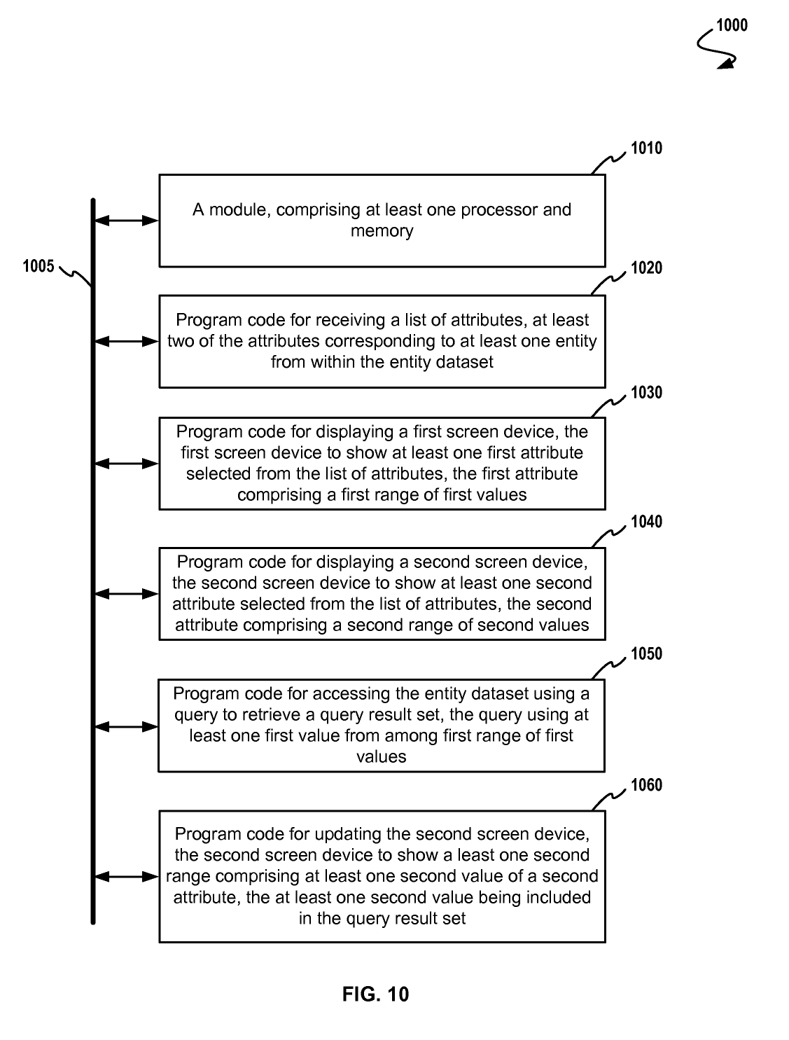

FIG. 10 depicts a block diagram of a system 1000 to perform certain functions of a computer system. As an option, the present system 1000 may be implemented in the context of the architecture and functionality of the embodiments described herein. Of course, however, the system 1000 or any operation therein may be carried out in any desired environment.

As shown, system 1000 comprises at least one processor and at least one memory, the memory serving to store program instructions corresponding to the operations of the system. As shown, an operation can be implemented in whole or in part using program instructions accessible by a module. The modules are connected to a communication path 1005, and any operation can communicate with other operations over communication path 1005. The modules of the system can, individually or in combination, perform method operations within system 1000. Any operations performed within system 1000 may be performed in any order unless as may be specified in the claims. The embodiment of FIG. 10 implements a portion of a computer system, shown as system 1000, comprising a computer processor to execute a set of program code instructions (see module 1010) and modules for accessing memory to hold program code instructions to perform: receiving a list of attributes, at least two of the attributes corresponding to at least one entity from within the entity dataset (see module 1020); displaying a first screen device, the first screen device to show at least one first attribute selected from the list of attributes, the first attribute comprising a first range of first values (see module 1030); displaying a second screen device, the second screen device to show at least one second attribute selected from the list of attributes, the second attribute comprising a second range of second values (see module 1040); accessing the entity dataset using a query to retrieve a query result set, the query using at least one first value from among first range of first values (see module 1050); and updating the second screen device, the second screen device to show at least one second range comprising at least one second value of a second attribute, the at least one second value being included in the query result set (see module 1060).

### Section III: Exemplary Practice of Embodiments

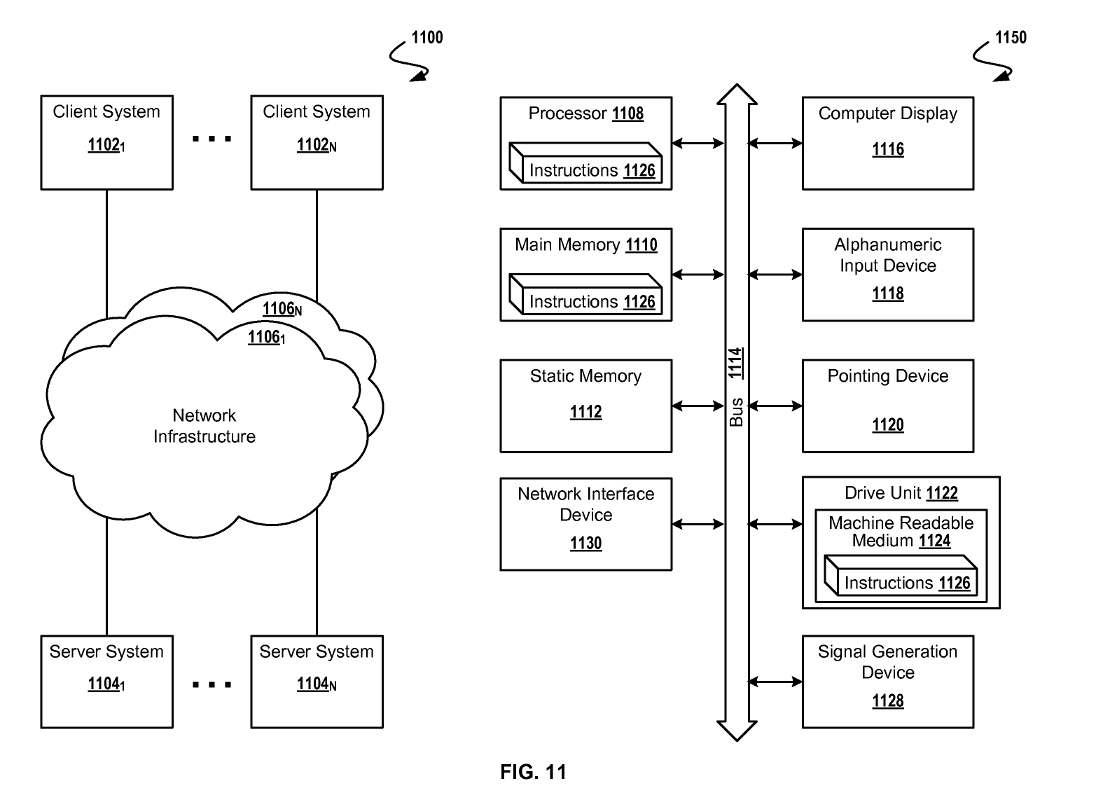

FIG. 11 depicts a computer system 1100, for implementing embodiments. The computer system 1100 includes nodes for client computer systems (e.g. client computer system 1102₁ through client computer system 1102_{N}), nodes for server computer systems (e.g. server computer system 1104₁ through server computer system 1104_{N}), and nodes for network infrastructure (e.g. network infrastructure node 1106₁ through network infrastructure node 1106_{N}), any of which nodes may comprise a machine (e.g. computer 1150) within which a set of instructions for causing the machine to perform any one of the techniques discussed above may be executed. The embodiment shown is purely exemplary, and might be implemented in the context of one or more of the figures herein.

Any node of the network may comprise a general-purpose processor, a digital signal processor (DSP), an application specific integrated circuit (ASIC), a field programmable gate array (FPGA) or other programmable logic device, a discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems (including a processor and memory), a massively parallel computer system, and/or a cloud computer system.

The computer system (e.g. computer 1150) includes a processor 1108 (e.g. a processor core, a microprocessor, a computing device, etc), a main memory (e.g. computer memory 1110), and a static memory 1112, which communicate with each other via a bus 1114. The computer 1150 may further include a display unit (e.g. computer display 1116) that may comprise a touch-screen, or a liquid crystal display (LCD), or a light emitting diode (LED) display, or a cathode ray tube (CRT). As shown, the computer system also includes a human input/output (I/O) device 1118 (e.g. a keyboard, an alphanumeric keypad, etc), a pointing device 1120 (e.g. a mouse, a touch screen, etc), a drive unit 1122 (e.g. a disk drive unit, a CD/DVD drive, a tangible computer readable removable media drive, an SSD storage device, etc), a signal generation device 1128 (e.g. a speaker, an audio output, etc), and a network interface device 1130 (e.g. an Ethernet interface, a wired network interface, a wireless network interface, a propagated signal interface, etc).The drive unit 1122 includes a machine-readable medium 1124 on which is stored a set of instructions (i.e. software, firmware, middleware, etc) 1126 embodying any one, or all, of the methodologies described above. The set of instructions 1126 is also shown to reside, completely or at least partially, within the main memory and/or within the processor 1108. The set of instructions 1126 may further be transmitted or received via the network interface device 1130 over the bus 1114.

It is to be understood that embodiments of this disclosure may be used as, or to support, a set of instructions executed upon some form of processing core (such as the CPU of a computer) or otherwise implemented or realized upon or within a machine- or computer-readable medium. A machine-readable medium includes any mechanism for storing non-transitory information in a form readable by a machine (e.g. a computer). For example, a machine-readable medium includes read-only memory (ROM); random access memory (RAM); magnetic disk storage media; optical storage media; flash memory devices; and electrical, optical or acoustical or any other type of media suitable for storing non-transitory information.

References are made to details of various embodiments, some examples of which are illustrated in the accompanying drawings. It will be understood that the described embodiments are not intended to limit the scope of the claims. On the contrary, the embodiments are intended to cover alternatives, modifications and equivalents, which may be included within the scope of the appended claims. Furthermore, in the detailed description, numerous specific details are set forth in order to provide a thorough understanding of the exemplary embodiments. However, one of ordinary skill in the art can recognize that the present advances may be practiced without these specific details. In other instances, well known methods, procedures, components, and circuits have not been described in detail so as avoid unnecessarily obscuring aspects of the described embodiments.

Some portions of the detailed descriptions are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc. as may be used herein is generally conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions using terms such as “processing” or “computing” or “communicating” or “instantiating” or “registering” or “selecting”, or “displaying” or the like refer to the actions and processes of a computer system or similar electronic computing device that manipulates and transforms data represented as physical (electronic) quantities within the computer system's registers and memories into other data similarly represented as physical quantities within the computer system's memories or registers or other such information storage, transmission or display devices.

While the figures and description have been described with reference to numerous specific details, one of ordinary skill in the art will recognize that the claimed embodiments can be differently embodied in other specific forms without departing from the scope of the claims.

We claim:

1. A computer-implemented method for searching an entity dataset using data-interrelated dynamically-updated screen devices, the method comprising:
receiving, by a computer, a list of attributes, at least two of the attributes corresponding to at least one entity from within the entity dataset;
displaying, on a display unit, a first screen device, the first screen device to show at least one first attribute selected from the list of attributes, the first attribute comprising a first range of first values;
displaying a second screen device, the second screen device to show at least one second attribute selected from the list of attributes, the second attribute comprising a second range of second values;
accessing the entity dataset using a query to retrieve a query result set, the query using at least one first value from among first range of first values;
updating the second screen device, the second screen device to show at least one second range comprising at least one second value of a second attribute, the at least one second value being included in the query result set.

2. The method of claim 1, wherein updating the second screen device comprises displaying a slider division series based on the second range.

3. The method of claim 1, wherein updating the second screen device comprises displaying an attribute label based on the second attribute.

4. The method of claim 1, further comprising analyzing the dataset to identify a second list of attributes.

5. The method of claim 1, wherein the first screen device and the second screen device are both dynamically-updated slider screen devices

6. The method of claim 1, wherein updating the second screen device comprises displaying a map screen device, the map screen device icons based on the second value.

7. The method of claim 1, further comprising resetting the search parameters.

8. A computer system to implement data-interrelated dynamically-updated screen devices, comprising:
a computer processor to execute a set of program code instructions; and
a memory to hold the program code instructions, in which the program code instructions comprises program code to perform, receiving a list of attributes, at least two of the attributes corresponding to at least one entity from within the entity dataset;
displaying a first screen device, the first screen device to show at least one first attribute selected from the list of attributes, the first attribute comprising a first range of first values;
displaying a second screen device, the second screen device to show at least one second attribute selected from the list of attributes, the second attribute comprising a second range of second values;
accessing the entity dataset using a query to retrieve a query result set, the query using at least one first value from among first range of first values;
updating the second screen device, the second screen device to show at least one second range comprising at least one second value of a second attribute, the at least one second value being included in the query result set.

9. The computer system of claim 8, wherein updating the second screen device comprises displaying a slider division series based on the second range.

10. The computer system of claim 8, wherein updating the second screen device comprises displaying an attribute label based on the second attribute.

11. The computer system of claim 8, further comprising analyzing the dataset to identify a second list of attributes.

12. The computer system of claim 8, wherein the first screen device and the second screen device are both dynamically-updated slider screen devices

13. The computer system of claim 8, wherein updating the second screen device comprises displaying a map screen device, the map screen device icons based on the second value.

14. The computer system of claim 8, further comprising resetting the search parameters.

15. A computer program product embodied in a non-transitory computer readable medium, the computer readable medium having stored thereon a sequence of instructions which, when executed by a processor causes the processor to execute a method to implement data-interrelated dynamically-updated screen devices, the method comprising:
receiving a list of attributes, at least two of the attributes corresponding to at least one entity from within the entity dataset;
displaying a first screen device, the first screen device to show at least one first attribute selected from the list of attributes, the first attribute comprising a first range of first values;
displaying a second screen device, the second screen device to show at least one second attribute selected from the list of attributes, the second attribute comprising a second range of second values;
accessing the entity dataset using a query to retrieve a query result set, the query using at least one first value from among first range of first values;
updating the second screen device, the second screen device to show at least one second range comprising at least one second value of a second attribute, the at least one second value being included in the query result set.

16. The computer program product of claim 15, wherein updating the second screen device comprises displaying a slider division series based on the second range.

17. The computer program product of claim 15, wherein updating the second screen device comprises displaying an attribute label based on the second attribute.

18. The computer program product of claim 15, further comprising analyzing the dataset to identify a second list of attributes.

19. The computer program product of claim 15, wherein the first screen device and the second screen device are both dynamically-updated slider screen devices

20. The computer program product of claim 15, wherein updating the second screen device comprises displaying a map screen device, the map screen device icons based on the second value.
